(19) United States
(12) Patent Application Publication
(10) Pub. No.: US 2023/0421268 A1
(43) Pub. Date: Dec. 28, 2023

(54) RECEIVER, RECEIVING DEVICE, COMMUNICATION DEVICE, AND COMMUNICATION SYSTEM

(71) Applicant: NEC CORPORATION, Tokyo (JP)

(72) Inventors: Koya Takata, Tokyo (JP); Hisashi Mizumoto, Tokyo (JP); Fujio Okumura, Kanagawa (JP)

(73) Assignee: NEC CORPORATION, Tokyo (JP)

(21) Appl. No.: 18/214,146

(22) Filed: Jun. 26, 2023

(30) Foreign Application Priority Data
Jun. 28, 2022 (JP) 2022-103155

(51) Int. Cl. H04B 10/67

(52) U.S. Cl. CPC H04B 10/67

(57) ABSTRACT

A receiver includes a light receiver including a light-receiving ring including a plurality of light-receiving elements arranged in an annular shape and a light-receiving plate including at least one light-receiving element, a ball lens placed on a ring formed by the light-receiving ring, and a reflector arranged in a gap formed between the light-receiving ring and the light-receiving plate. The plurality of light-receiving elements constituting the light-receiving ring are arranged with a light-receiving surface facing an inner side of the ring formed by the light-receiving ring. The light-receiving element included in the light-receiving plate is disposed inside the ring formed by the light-receiving ring with a light-receiving surface facing the ball lens placed on the light-receiving ring.

This application is based upon and claims the benefit of priority from Japanese Patent Application No. 2022-103155, filed on Jun. 28, 2022, the disclosure of which is incorporated herein in its entirety by reference.

### TECHNICAL FIELD

The present disclosure relates to a receiver or the like that receives a light signal propagating in a space.

### BACKGROUND ART

In optical space communication, light signals (hereinafter, also referred to as spatial light signals) propagating in a space are transmitted and received without using a medium such as an optical fiber. In order to receive a spatial light signal spreading and propagating in a space, it is preferable to use a lens having as large a diameter as possible. Furthermore, in the optical space communication, a light-receiving element having a small capacitance is adopted in order to perform high-speed communication. In such a light-receiving element, a light-receiving portion has a small area. Since the focal length of the lens is limited, it is difficult to guide spatial light signals arriving from various directions to a light-receiving portion having a small area using a large-diameter lens.

Patent Literature 1 (JP S63-095407 A) discloses an optical receiving device including a spherical lens, an optical fiber bundle, and at least one light-receiving element. The spherical lens condenses light incident from a wide angle on one end surface of the optical fiber bundle. The optical fiber bundle is a bundle structure in which a plurality of optical fibers are aggregated. One end surface of the optical fiber bundle is a planar-shaped light incident portion. The light incident portion is provided at a focal point distribution position of the spherical lens. The at least one light-receiving element is provided on the other end surface of the optical fiber bundle. The at least one light-receiving element receives light emitted from the other end face of the optical fiber bundle.

The device of Patent Literature 1 receives light condensed by the spherical lens using the optical fiber bundle including a plurality of optical fibers. The angle at which individual optical fibers can condense light is very limited. Therefore, the incident surfaces of the individual optical fibers need to be arranged substantially perpendicular to the outer peripheral surface of the spherical lens. As a result, in the device of Patent Literature 1, one end surface side of the optical fiber bundle becomes larger than the diameter of the spherical lens, and light arriving at the spherical lens is blocked by the optical fiber bundle.

Even if the optical fiber is not used, for example, if the periphery of a ball lens is surrounded by a belt-shaped sensor array including a plurality of light-receiving elements, it is possible to receive a light signal arriving from directions of 360 degrees. However, the light signal condensed in the gap between the ball lens and the sensor array cannot be received by the sensor array. Therefore, it is not possible to efficiently receive light signals arriving from various directions only by surrounding the periphery of the ball lens with the sensor array.

An object of the present disclosure is to provide a receiver and the like capable of efficiently receiving light signals arriving from various directions.

### SUMMARY

A receiver according to one aspect of the present disclosure includes a light receiver including a light-receiving ring including a plurality of light-receiving elements arranged in an annular shape and a light-receiving plate including at least one light-receiving element, a ball lens placed on a ring formed by the light-receiving ring, and a reflector arranged in a gap formed between the light-receiving ring and the light-receiving plate. The plurality of light-receiving elements constituting the light-receiving ring are arranged with a light-receiving surface facing an inner side of the ring formed by the light-receiving ring. The light-receiving element included in the light-receiving plate is disposed inside the ring formed by the light-receiving ring with a light-receiving surface facing the ball lens placed on the light-receiving ring.

### BRIEF DESCRIPTION OF THE DRAWINGS

Exemplary features and advantages of the present invention will become apparent from the following detailed description when taken with the accompanying drawings in which:

FIG. 1 is a conceptual diagram illustrating an example of a configuration of a receiving device according to a first example embodiment;

FIG. 2 is a conceptual diagram illustrating an example of a configuration of a receiver according to the first example embodiment;

FIG. 3 is a conceptual diagram illustrating an example of a configuration of the receiver according to the first example embodiment;

FIG. 4 is a conceptual diagram illustrating an example of a light-receiving surface of a light-receiving element included in a light receiver according to the first example embodiment;

FIG. 5 is a conceptual diagram illustrating another example of the light-receiving element included in the light receiver according to the first example embodiment;

FIG. 6 is a conceptual diagram for describing an example of a configuration of a receiving circuit included in the receiving device according to the first example embodiment;

FIG. 7 is a conceptual diagram for describing an example of a configuration of a reception control unit included in the receiving circuit according to the first example embodiment;

FIG. 8 is a conceptual diagram illustrating an example of reception of a light signal by the light receiver according to the first example embodiment;

FIG. 9 is a conceptual diagram illustrating an example of reception of a light signal by the light receiver according to the first example embodiment;

FIG. 10 is a conceptual diagram illustrating an example of reception of a light signal by the light receiver according to the first example embodiment;

FIG. 11 is a conceptual diagram illustrating an example of reception of a light signal by the light receiver according to the first example embodiment;

FIG. 12 is a conceptual diagram illustrating an example of reception of a light signal by the light receiver according to the first example embodiment;

FIG. 13 is a conceptual diagram illustrating an example of a configuration of a light receiver of Modification Example 1 according to the first example embodiment;

FIG. 14 is a conceptual diagram illustrating an example of a configuration of a reflecting body included in a light receiver of Modification Example 1 according to the first example embodiment;

FIG. 15 is a conceptual diagram illustrating an example of a configuration of a light receiver of Modification Example 2 according to the first example embodiment;

FIG. 16 is a conceptual diagram illustrating an example of a configuration of a light receiver of Modification Example 2 according to the first example embodiment;

FIG. 17 is a conceptual diagram illustrating an example of a configuration of a light receiver of Modification Example 3 according to the first example embodiment;

FIG. 18 is a conceptual diagram illustrating an example of a configuration of a light receiver of Modification Example 3 according to the first example embodiment;

FIG. 19 is a conceptual diagram illustrating an example of a configuration of a light receiver of Modification Example 3 according to the first example embodiment;

FIG. 20 is a conceptual diagram for describing an example of modulation of a spatial light signal by a light receiver of Modification Example 3 according to the first example embodiment;

FIG. 21 is a conceptual diagram illustrating an example of a configuration of a light receiver according to a related art;

FIG. 22 is a block diagram illustrating an example of a configuration of a communication device according to a second example embodiment;

FIG. 23 is a conceptual diagram illustrating an example of a configuration of a transmitting device according to a second example embodiment;

FIG. 24 is a conceptual diagram for explaining Application Example 1 according to the second example embodiment;

FIG. 25 is a conceptual diagram for describing Application Example 2 according to the second example embodiment;

FIG. 26 is a conceptual diagram for explaining Application Example 3 according to the second example embodiment;

FIG. 27 is a conceptual diagram illustrating an example of a configuration of a receiver according to a third example embodiment;

FIG. 28 is a conceptual diagram illustrating an example of a configuration of a receiver according to the third example embodiment; and

FIG. 29 is a block diagram illustrating an example of a hardware configuration that executes processing and control according to each example embodiment.

### EXAMPLE EMBODIMENT

Example embodiments of the present invention will be described below with reference to the drawings. In the following example embodiments, technically preferable limitations are imposed to carry out the present invention, but the scope of this invention is not limited to the following description. In all drawings used to describe the following example embodiments, the same reference numerals denote similar parts unless otherwise specified. In addition, in the following example embodiments, a repetitive description of similar configurations or arrangements and operations may be omitted.

In all the drawings used for description of the following example embodiments, the directions of the arrows in the drawings are merely examples, and do not limit the directions of light and signals. In addition, a line indicating a trajectory of light in the drawings is conceptual, and does not accurately indicate an actual traveling direction or state of light. For example, in the drawings, a change in a traveling direction or a state of light due to refraction, reflection, diffusion, or the like at an interface between air and a substance may be omitted, or a light flux may be expressed by one line. In addition, there is a case where hatching is not applied to the cross-section for reasons such as showing an example of the path of light or the configuration being complicated.

### First Example Embodiment

First, a receiving device according to the present example embodiment will be described with reference to the drawings. The receiving device of the present example embodiment is used for optical space communication in which light signals (hereinafter, also referred to as spatial light signals) propagating in a space are transmitted and received without using a medium such as an optical fiber. The receiving device of the present example embodiment may be used for applications other than optical space communication as long as the receiving device receives light propagating in a space. In the present example embodiment, unless otherwise specified, the spatial light signal is regarded as parallel light because it arrives from a sufficiently distant position. Note that the drawings used in the description of the present example embodiment are conceptual and do not accurately depict an actual structure.

(Configuration)

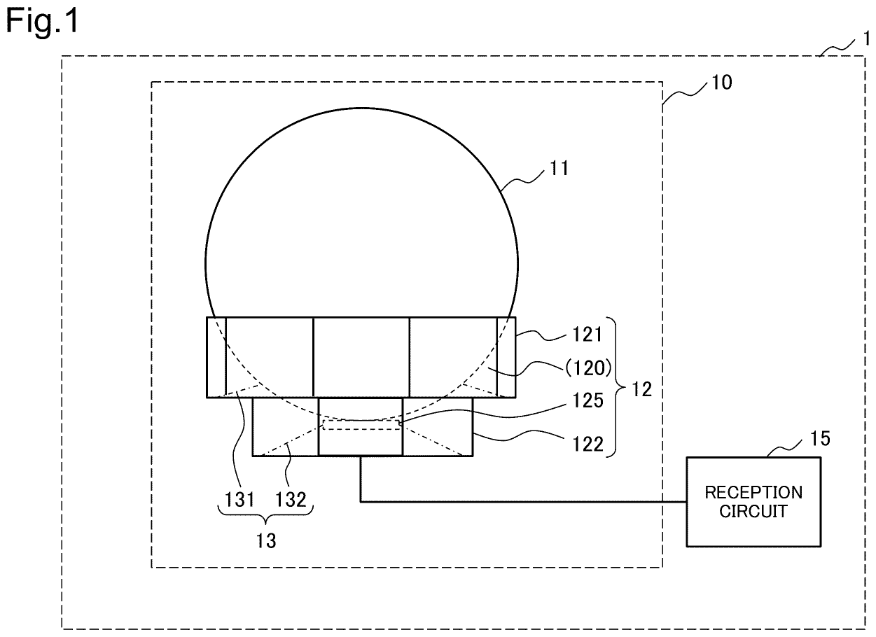

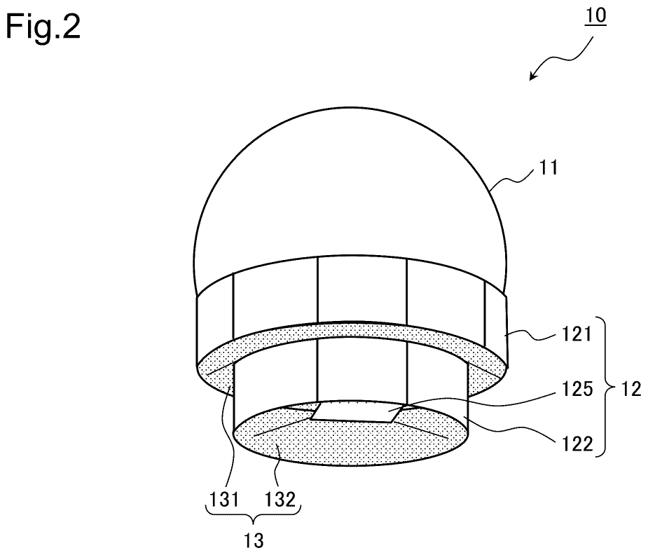

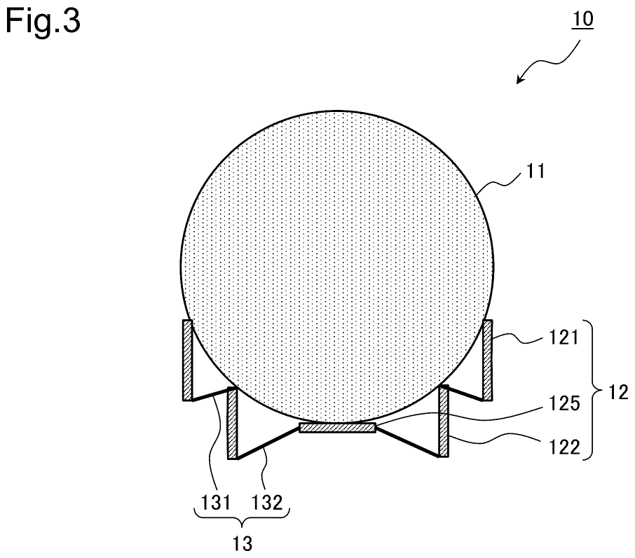

FIG. 1 is a conceptual diagram illustrating an example of a configuration of a receiving device 1 according to the present example embodiment. The receiving device 1 includes a ball lens 11, a light receiver 12, a reflector 13, and a receiving circuit 15. The ball lens 11, the light receiver 12, and the reflector 13 constitute a receiver 10. The light receiver 12 and the reflector 13 constitute a light-receiving unit. FIG. 1 is a side view of the receiver 10 as viewed from the side. In FIG. 1, the reflector 13 hidden by the light receiver 12 and a portion of the light receiver 12 are indicated by broken lines. FIG. 2 is a conceptual diagram of the receiver 10 viewed from an obliquely lower side. FIG. 3 is a cross-sectional view of the receiver 10.

A positional relationship among the ball lens 11, the light receiver 12, and the reflector 13 is fixed by a support (not illustrated). In the present example embodiment, the support for fixing the positions of the light receiver 12 and the reflector 13 with respect to the ball lens 11 is omitted. Furthermore, the position of the receiving circuit is not particularly limited as long as the reception of the spatial light signal is not affected.

The ball lens 11 is a spherical lens. The ball lens 11 is an optical element that condenses a spatial light signal arriving from the outside. The ball lens 11 has a spherical shape when viewed from an arbitrary angle. The ball lens 11 condenses the incident spatial light signal. Light (also referred to as a light signal) derived from the spatial light signal condensed by the ball lens 11 is condensed toward the condensing region of the ball lens 11. Since the ball lens 11 has a spherical shape, the ball lens condenses a spatial light signal arriving from an arbitrary direction. That is, the ball lens 11 exhibits similar light condensing performance for a spatial light signal arriving from an arbitrary direction. The light incident on the ball lens 11 is refracted when entering the inside of the ball lens 11. Furthermore, the light traveling inside the ball lens 11 is refracted again when being emitted to the outside of the ball lens 11. Most of the light emitted from the ball lens 11 is condensed in the condensing region. On the other hand, the light incident from the periphery of the ball lens 11 is emitted in a direction deviated from the condensing region when being emitted from the ball lens 11.

For example, the ball lens 11 can be made of a material such as glass, crystal, or resin. In the case of receiving a spatial light signal in the visible region, a material such as glass, crystal, or resin that transmits/refracts light in the visible region can be applied to the ball lens 11. For example, optical glass such as crown glass or flint glass can be applied to the ball lens 11. For example, crown glass such as BK (Boron Kron) can be applied to the ball lens 11. For example, a flint glass such as Lanthanum Schwerflint (LaSF) can be applied to the ball lens 11. For example, quartz glass can be applied to the ball lens 11. For example, a crystal such as sapphire can be applied to the ball lens 11. For example, a transparent resin such as acryl can be applied to the ball lens 11.

In a case where the spatial light signal is light in the near-infrared region (hereinafter, also referred to as a near-infrared ray), a material that transmits near-infrared rays is used for the ball lens 11. For example, in a case of receiving a spatial light signal in the near-infrared region of about 1.5 micrometers (m), a material such as silicon can be applied to the ball lens 11 in addition to glass, crystal, resin, and the like. In a case where the spatial light signal is light in the infrared region (hereinafter, also referred to as an infrared ray), a material that transmits infrared rays is used for the ball lens 11. For example, in a case where the spatial light signal is an infrared ray, silicon, germanium, or a chalcogenide material can be applied to the ball lens 11. The material of the ball lens 11 is not limited as long as light in the wavelength region of the spatial light signal can be transmitted/refracted. The material of the ball lens 11 may be appropriately selected according to the required refractive index and use.

The light receiver 12 includes a first light-receiving ring 121, a second light-receiving ring 122, and a light-receiving plate 125. The light receiver 12 has a two-stage configuration including the first light-receiving ring 121 and the second light-receiving ring 122. The first light-receiving ring 121 and the second light-receiving ring 122 are constituted by a plurality of light-receiving elements 120. The light-receiving plate 125 includes a single light-receiving element 120. The light-receiving plate 125 may include a plurality of light-receiving elements 120. The light-receiving plate 125 is disposed inside the ring formed by the second light-receiving ring 122 with the light-receiving surface facing the ball lens 11. In the example of FIGS. 1 to 3, the light-receiving surface of the light-receiving plate 125 is in contact with the bottom of the ball lens 11. The light-receiving surface of the light-receiving plate 125 may be away from the bottom of the ball lens 11. The sizes of the light-receiving elements 120 used in the first light-receiving ring 121, the second light-receiving ring 122, and the light-receiving plate 125 may be different. For example, the type and number of the light-receiving elements 120 used for the first light-receiving ring 121, the second light-receiving ring 122, and the light-receiving plate 125 may be different from each other.

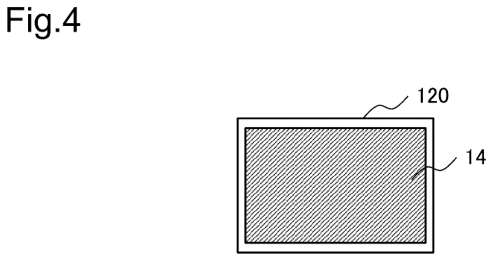

FIG. 4 is a conceptual diagram illustrating an example of a light-receiving surface of the light-receiving element 120. The light-receiving surface of the light-receiving element 120 includes a light-receiving portion 14 that receives a light signal derived from a spatial light signal to be received. The light-receiving surface of the light-receiving element 120 includes a region (also referred to as a light-receiving region) of the light-receiving portion 14 and a region (also referred to as a dead region) where the light-receiving portion 14 is not located. The light signal reaching the light-receiving region is received by the light-receiving portion 14 of the light-receiving element 120. The light signal that has reached the dead region is not received.

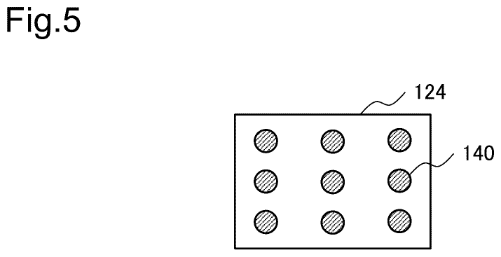

FIG. 5 is a conceptual diagram illustrating another example (light-receiving element array 124) of the light-receiving element 120. The plurality of light-receiving elements 140 is arranged in a two-dimensional array on the light-receiving surface of the light-receiving element array 124. The plurality of light-receiving elements 140 include a light-receiving portion that receives a light signal derived from a spatial light signal to be received. A surface on which the plurality of light-receiving elements 140 is arranged is a light-receiving surface. The light-receiving surface of the light-receiving element array 124 includes a light-receiving region where the light-receiving portion of the light-receiving element 140 is located and a dead region where the light-receiving portion is not located. The light signal reaching the light-receiving region is received by the light-receiving portion of the light-receiving element 140. The light signal that has reached the dead region is not received. In the case of the example of FIG. 5, one light-receiving group is including nine light-receiving elements 140. The plurality of light-receiving elements 140 collectively receives light signals derived from spatial light signals arriving from the same direction by a light-receiving group including several elements. When high-speed light-receiving elements 140 having a small light-receiving area are arranged in an array, high-speed communication can be supported.

The light-receiving element 120 receives light in a wavelength region of the spatial light signal to be received. For example, the light-receiving element 120 is sensitive to light in the visible region. For example, the light-receiving element 120 is sensitive to light in the infrared region. The light-receiving element 120 is sensitive to light having a wavelength in a 1.5 μm (micrometers) band, for example. Note that the wavelength band of light to which the light-receiving element 120 is sensitive is not limited to the 1.5 μm band. The wavelength band of the light received by the light-receiving element 120 can be arbitrarily set in accordance with the wavelength of the spatial light signal transmitted from the transmitting device (not illustrated). The wavelength band of the light received by the light-receiving element 120 may be set to, for example, a 0.8 μm band, a 1.55 μm band, or a 2.2 μm band. Furthermore, the wavelength band of the light received by the light-receiving element 120 may be, for example, a 0.8 to 1 μm band. A shorter wavelength band is advantageous for optical spatial communication during rainfall because absorption by moisture in the atmosphere is small. In addition, if the light-receiving element 120 is saturated with intense sunlight, the light-receiving element cannot read the light signal derived from the spatial light signal. Therefore, a color filter that selectively passes the light of the wavelength band of the spatial light signal may be installed in the preceding stage of the light-receiving element 120.

For example, the light-receiving element 120 can be realized by an element such as a photodiode or a phototransistor. For example, the light-receiving element 120 is realized by an avalanche photodiode. The light-receiving element 120 realized by the avalanche photodiode can support high-speed communication. Note that the light-receiving element 120 may be realized by an element other than a photodiode, a phototransistor, or an avalanche photodiode as long as a light signal can be converted into an electric signal. In order to improve the communication speed, the light-receiving portion of the light-receiving element 120 is preferably as small as possible. For example, the light-receiving portion of the light-receiving element 120 has a square light-receiving surface having a side of about 5 mm (millimeters). For example, the light-receiving portion of the light-receiving element 120 has a circular light-receiving surface having a diameter of about 0.1 to 0.3 mm. The size and shape of the light-receiving portion of the light-receiving element 120 may be selected according to the wavelength band, the communication speed, and the like of the spatial light signal.

The light-receiving elements 120 constituting the first light-receiving ring 121 and the second light-receiving ring 122 are arranged in an annular shape with their light-receiving surfaces facing inward. The diameter of the ring formed by the second light-receiving ring 122 is smaller than the diameter of the ring formed by the first light-receiving ring 121. The plurality of light-receiving elements 120 constituting the first light-receiving ring 121 is arranged in an annular shape such that there is no gap between the light-receiving elements 120 adjacent to each other. Similarly, the plurality of light-receiving elements 120 constituting the second light-receiving ring 122 is arranged in an annular shape such that there is no gap between the light-receiving elements 120 adjacent to each other. Since the light-receiving surface of the light-receiving element 120 is a flat surface, the ring formed by the plurality of light-receiving elements 120 arranged in an annular shape is a polygonal ring. Hereinafter, the plurality of light-receiving elements 120 arranged in an annular shape may be regarded as forming an annular ring. Hereinafter, in the case of the diameter of the ring, a polygonal ring is regarded as an annular ring. Hereinafter, the expression of the diameter of the ring is not a specific diameter of the annular ring, but a relative magnitude relationship of the sizes of the rings formed by the first light-receiving ring 121 and the second light-receiving ring 122.

As illustrated in FIGS. 1 to 3, the diameter of the ring of the first light-receiving ring 121 is larger than that of the second light-receiving ring 122. That is, the diameter of the ring formed by the first light-receiving ring 121 is larger than the diameter of the ring formed by the second light-receiving ring 122. In addition, the diameter of the ring formed by the first light-receiving ring 121 and the second light-receiving ring 122 is smaller than the diameter of the ball lens 11. The first light-receiving ring 121 and the second light-receiving ring 122 are arranged below the ball lens 11. The first light-receiving ring 121 and the second light-receiving ring 122 are arranged so as to be in contact with a portion of the lower part of the ball lens 11. Since the diameter of the ring of the first light-receiving ring 121 is larger than that of the second light-receiving ring 122, the second light-receiving ring 122 is disposed below the first light-receiving ring 121. The light-receiving plate 125 is disposed at the bottom of the ball lens 11 with the light-receiving surface facing the ball lens 11. In the present example embodiment, an example in which the light receiver 12 is disposed below the ball lens 11 will be described. The positional relationship of the light receiver 12 with respect to the ball lens 11 depends on the arrangement of the receiver 10. When the receiver 10 is disposed on the floor surface, the light receiver 12 is disposed below the ball lens 11. When the receiver 10 is disposed on the ceiling, the light receiver 12 is disposed above the ball lens 11. When the receiver 10 is disposed on the wall, the light receiver 12 is disposed on the side of the ball lens 11.

The reflector 13 is disposed in a gap between the ball lens 11 and the light receiver 12. The reflector 13 includes a first reflector 131 and a second reflector 132. The first reflector 131 is disposed in an annular gap formed between the first light-receiving ring 121 and the second light-receiving ring 122. The second reflector 132 is disposed in an annular gap formed between the second light-receiving ring 122 and the light-receiving plate 125. In the example of FIGS. 1 to 3, the first reflector 131 and the second reflector 132 are annual. The first reflector 131 and the second reflector 132 have reflecting surfaces that reflect light signals. The first reflector 131 and the second reflector 132 are disposed with their reflecting surfaces facing the ball lens 11.

The first reflector 131 includes a large ring and a small ring. The larger ring formed by the first reflector 131 has the same diameter as the ring of the first light-receiving ring 121. The larger ring is arranged in accordance with the lower ring of the first light-receiving ring 121. The smaller ring formed by the first reflector 131 has the same diameter as the ring of the second light-receiving ring 122. The smaller ring is arranged in accordance with the upper ring of the second light-receiving ring 122. The first reflector 131 fills a gap between the first light-receiving ring 121 and the second light-receiving ring 122. The first reflector 131 reflects the light signal condensed in the gap between the first light-receiving ring 121 and the second light-receiving ring 122.

The second reflector 132 includes a large ring and a small ring. The larger ring formed by the second reflector 132 has the same diameter as the ring of the second light-receiving ring 122. The larger ring is arranged in accordance with the lower ring of the second light-receiving ring 122. The smaller ring formed by the second reflector 132 has a diameter corresponding to the size of the light-receiving plate 125. The smaller ring is arranged in accordance with the size of the light-receiving plate 125. The light-receiving plate 125 is not necessarily circular. Therefore, the smaller ring may be formed in accordance with the outer shape of the light-receiving plate 125. The second reflector 132 fills a gap between the second light-receiving ring 122 and a photoreceptor 145. The second reflector 132 reflects the light signal condensed in the gap between the second light-receiving ring 122 and the photoreceptor 145.

The light signal condensed by the ball lens 11 is incident on each of the plurality of light-receiving elements 120 constituting the light receiver 12. The light signal reflected by the reflector 13 is incident on each of the plurality of light-receiving elements 120 constituting the light receiver 12. Each of the plurality of light-receiving elements 120 receives the incident light signal. Each of the plurality of light-receiving elements 120 converts the received light signal into an electric signal. Each of the plurality of light-receiving elements 120 outputs the converted electric signal to the receiving circuit 15.

The receiving circuit 15 acquires a signal output from each of the plurality of light-receiving elements 120. The receiving circuit 15 amplifies a signal from each of the plurality of light-receiving elements 120. The receiving circuit 15 decodes the amplified signal and analyzes a signal from a communication target. For example, the receiving circuit 15 is configured to collectively analyze signals of the plurality of light-receiving elements 120 included in the same light-receiving group. When the signals of the plurality of light-receiving elements 120 are analyzed collectively, it is possible to realize the single-channel receiving device 1 that communicates with a single communication target. For example, the receiving circuit 15 is configured to individually analyze a signal for each light-receiving element 120. In a case where signals are analyzed individually for each light-receiving element 120, it is possible to realize the multi-channel receiving device 1 that communicates with a plurality of communication targets simultaneously. The signal decoded by the receiving circuit 15 is used for any purpose. The use of the signal decoded by the receiving circuit 15 is not particularly limited.

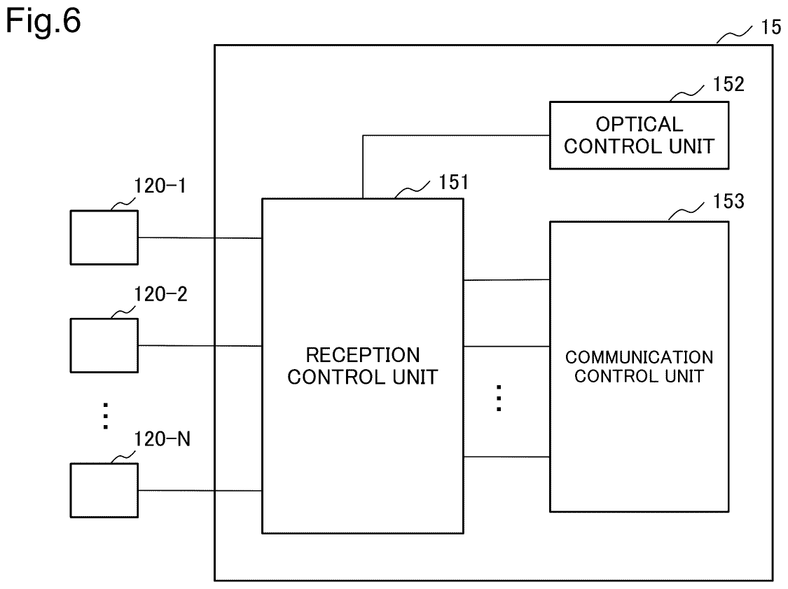

FIG. 6 is a block diagram illustrating an example of a configuration of the receiving circuit 15. In the example of FIG. 6, the number of the plurality of light-receiving elements 120 is N (N is a natural number). The receiving circuit 15 includes a reception control unit 151, an optical control unit 152, and a communication control unit 153. The plurality of light-receiving elements 120-1 to N is connected to the reception control unit 151. Signals output from the plurality of light-receiving elements 120-1 to N are input to the reception control unit 151. The reception control unit 151 amplifies the input signal. The reception control unit 151 outputs the amplified signal to the communication control unit 153. FIG. 6 is an example of the configuration of the receiving circuit 15, and does not limit the configuration of the receiving circuit 15.

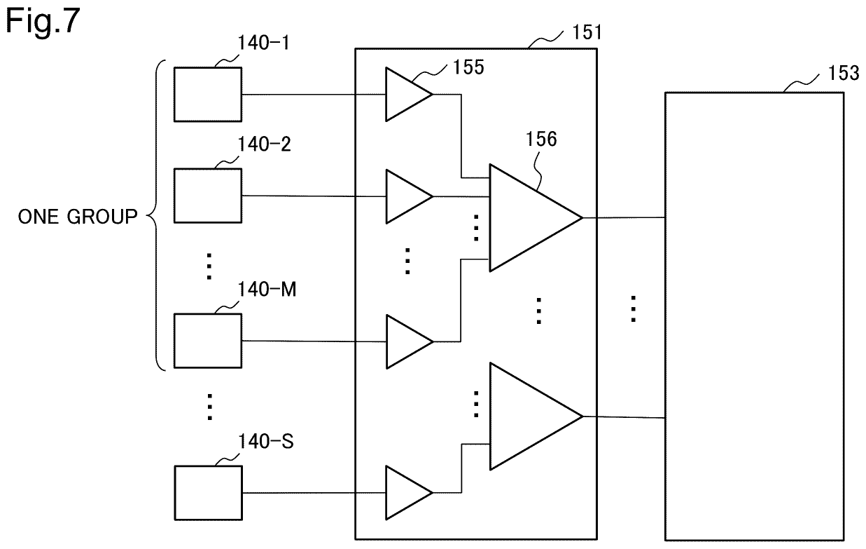

FIG. 7 is a conceptual diagram illustrating an example of a configuration of the reception control unit 151 related to the example of FIG. 5 (light-receiving element array 124). In the example of FIG. 7, the number of the plurality of light-receiving elements 140 included in the light-receiving element array 124 is S (S is a natural number). In the example of FIG. 7, the reception control unit 151 includes a plurality of first amplifiers 155 and a plurality of second amplifiers 156. The first amplifier 155 is connected to any one of the plurality of light-receiving elements 140-1 to S included in the light-receiving element array 124. The first amplifier 155 amplifies the input signal. The first amplifier 155 outputs the amplified signal to the second amplifier 156. The plurality of light-receiving elements 140-1 to S are assigned to one of the plurality of light-receiving groups. In the example of FIG. 7, one light-receiving group includes M light-receiving elements 140 (M is a natural number smaller than N). Each of the plurality of second amplifiers 156 is assigned to any light-receiving group. The signals output from the plurality of first amplifiers 155 belonging to the assigned light-receiving group are input to the second amplifier 156. The second amplifier 156 amplifies the input signal collectively for each light-receiving group. The second amplifier 156 outputs the signal amplified for each light-receiving group to the communication control unit 153. FIG. 7 is an example of the configuration of the reception control unit 151 related to the example of FIG. 5 (light-receiving element array 124), and does not limit the configuration of the reception control unit 151.

For example, in the reception control unit 151, a limiting amplifier (not illustrated) may be provided in the preceding stage of the first amplifier 155. When the limiting amplifier is provided, a dynamic range can be secured. For example, the reception control unit 151 may be provided with a high-pass filter or a band-pass filter (not illustrated). The high-pass filter and the band-pass filter cut a signal derived from ambient light such as sunlight, and selectively pass a signal of a high frequency component corresponding to a wavelength band of a spatial light signal. For example, the reception control unit 151 may be provided with a band-pass filter (not illustrated).

The optical control unit 152 is connected to the reception control unit 151. The optical control unit 152 acquires an output value of the signal amplified by the reception control unit 151. The optical control unit 152 monitors the output value of the signal.

The communication control unit 153 is connected to the reception control unit 151. The communication control unit 153 acquires the signal amplified by the reception control unit 151. That is, the communication control unit 153 acquires a signal derived from a light signal received by each of the plurality of light-receiving elements 140-1 to S. The communication control unit 153 decodes the acquired signal. For example, the communication control unit 153 is configured to apply some signal processing to the decoded signal. For example, the communication control unit 153 is configured to output the decoded signal to an external signal processing device or the like (not illustrated).

### Light Reception Example

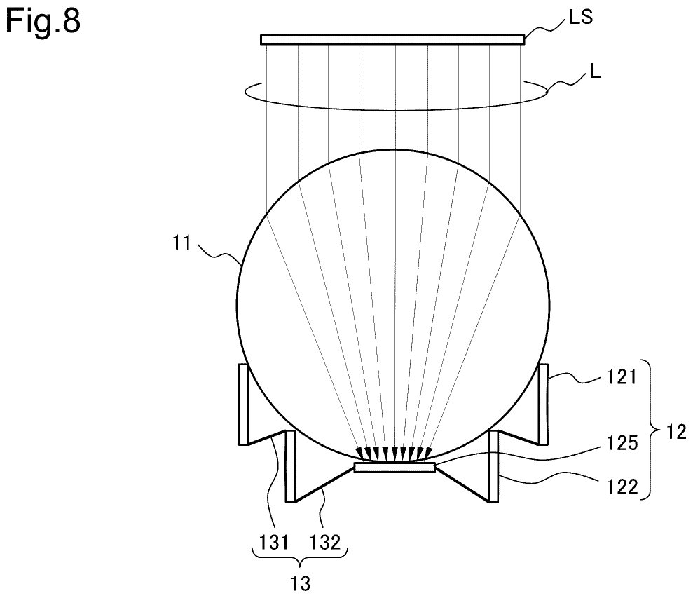

Next, an example of reception of a light signal by the light receiver 12 will be described with some examples. FIGS. 8 to 12 are conceptual diagrams for describing an example of reception of a light signal by the light receiver 12. The examples of FIGS. 8 to 12 illustrate a state in which the light-receiving position of the light condensed by the ball lens 11 changes according to a change in the position (inclination) of the light source LS that emits the light L. Hereinafter, the incident direction of light is described with reference to the light-receiving surface of the light-receiving plate 125.

FIG. 8 illustrates an example in which the light L arrives from a direction in which the elevation angle is 90 degrees. In the example of FIG. 8, the angle between the light-receiving surface of the light-receiving plate 125 and the arrival direction of the light L is 0 degrees. The light L condensed by the ball lens 11 is received by the light-receiving plate 125.

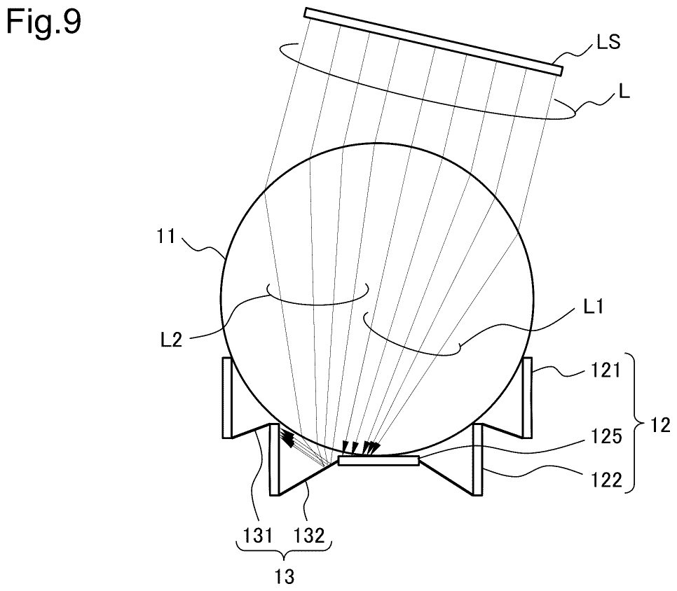

FIG. 9 illustrates an example in which the light L arrives from a direction in which the elevation angle is about 75 degrees. In the example of FIG. 9, the angle between the light-receiving surface of the light-receiving plate 125 and the arrival direction of the light L is about 15 degrees. The light condensed by the ball lens 11 is divided into a light component L1 received by the light-receiving plate 125 and a light component L2 received by the second light-receiving ring 122. The light component L1 is received by the light-receiving plate 125. The light component L2 is reflected by the reflecting surface of the second reflector 132 and received by the second light-receiving ring 122.

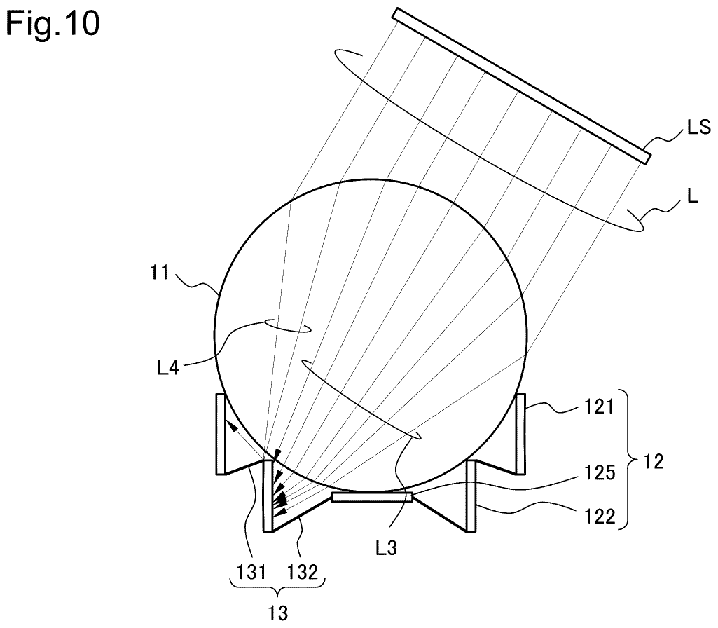

FIG. 10 illustrates an example in which the light L arrives from a direction in which the elevation angle is about 60 degrees. In the example of FIG. 10, the angle between the light-receiving surface of the light-receiving plate 125 and the arrival direction of the light L is about 30 degrees. The light condensed by the ball lens 11 is divided into a light component L3 received by the second light-receiving ring 122 and a light component L4 received by the first light-receiving ring 121. The light component L3 is received by the second light-receiving ring 122. The light component L4 is reflected by the reflecting surface of the first reflector 131 and received by the first light-receiving ring 121.

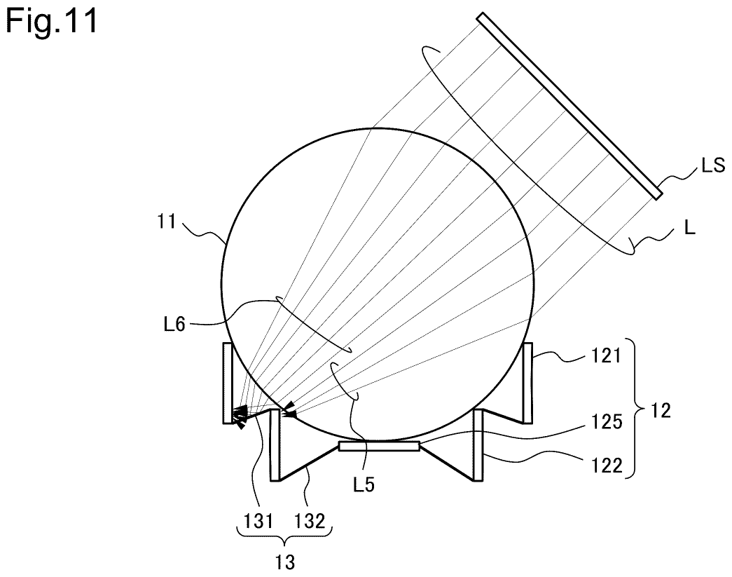

FIG. 11 illustrates an example in which the light L arrives from a direction in which the elevation angle is about 45 degrees. In the example of FIG. 11, the angle between the light-receiving surface of the light-receiving plate 125 and the arrival direction of the light L is about 45 degrees. The light condensed by the ball lens 11 is divided into a light component L5 received by the second light-receiving ring 122 and a light component L6 received by the first light-receiving ring 121. The light component L5 is received by the second light-receiving ring 122. The light component L6 is reflected by the reflecting surface of the first reflector 131 and received by the first light-receiving ring 121.

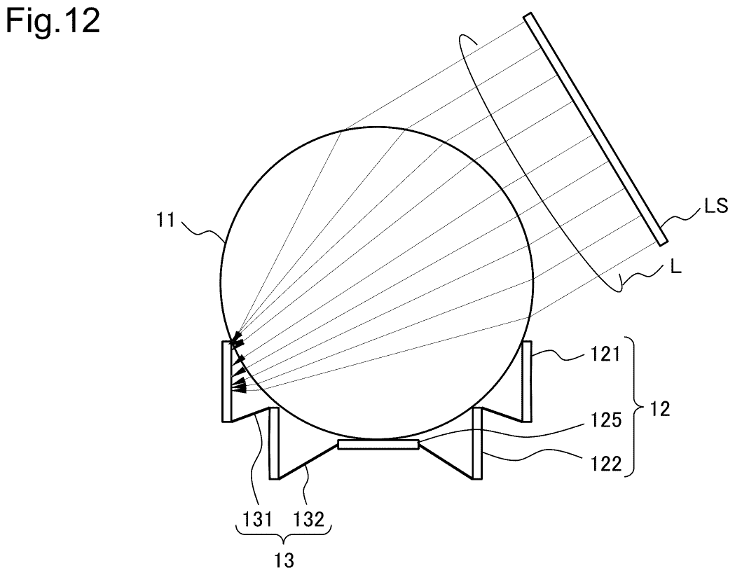

FIG. 12 illustrates an example in which the light L arrives from a direction in which the elevation angle is about 30 degrees. In the example of FIG. 12, the angle between the light-receiving surface of the light-receiving plate 125 and the arrival direction of the light L is about 60 degrees. The light L condensed by the ball lens 11 is received by the first light-receiving ring 121.

As illustrated in FIGS. 8 to 12, by using the light receiver 12 of the present example embodiment, it is possible to receive a spatial light signal arriving from a wide range with an elevation angle of 30 to 90 degrees. For example, the direction of the transmission source of the spatial light signal can be specified according to the position of the light-receiving element receiving the light signal. Furthermore, if the receiver 10 is tilted in accordance with the arrival direction of the spatial light signal to be received, the spatial light signal can be received more efficiently. If a mechanism capable of dynamically controlling the angle of the receiver 10 is provided, the spatial light signal arriving from an arbitrary direction can be more accurately received.

### Modification Example

Next, a modification example of the receiver 10 included in the receiving device 1 of the present example embodiment will be described. Hereinafter, characteristic portions of the modification example will be described. The following modification example is an example, and does not limit the modification example of the receiver 10.

### Modification Example 1

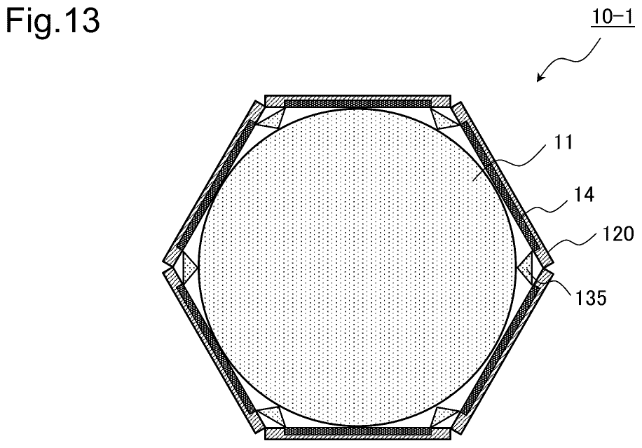

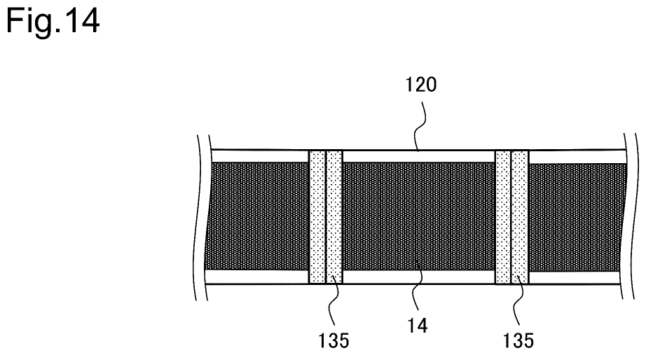

FIGS. 13 to 14 are conceptual diagrams for describing a receiver 10-1 of Modification Example 1. FIG. 13 is a cross-sectional view of the receiver 10-1 taken along an upper end portion of the light-receiving element 120. FIG. 14 is a front view of the light-receiving portion 14 of the light-receiving elements 120 of a portion of the receiver 10-1 as viewed from the ball lens 11.

A dead region is formed around the light-receiving portion 14 of the light-receiving element 120. The light signal condensed in the dead region is not received by the light-receiving element 120. In the present modification example, the reflecting body 135 is disposed in a dead region formed between the light-receiving portions 14 of the light-receiving elements 120 adjacent to each other.

The reflecting body 135 is a triangular prism having a triangular cross-section. The reflecting body 135 is disposed in a dead region formed between the light-receiving portions 14 of the light-receiving elements 120 adjacent to each other. Two of the three side surfaces of the reflecting body 135 are reflecting surfaces. The two reflecting surfaces of the reflecting body 135 are directed to the ball lens 11. In the example of FIG. 13, the cross-section of the reflecting body 135 is an isosceles triangle. The vertex angle of the reflecting body 135 at the upper end portion of the light-receiving element 120 is disposed so as to be in contact with the ball lens 11. The distance between the vertex angle of the reflecting body 135 and the ball lens 11 increases as it goes downward from the upper end portion of the light-receiving element 120.

Of the light signal condensed by the ball lens 11, the light component condensed on the reflecting surface of the reflecting body 135 is reflected toward the light-receiving portion 14 adjacent to the reflecting surface. The light component reflected toward the light-receiving portion 14 is received by the light-receiving element 120 arranged in the light-receiving portion 14. In the present modification example, the light-receiving efficiency is improved by the amount of the light signal condensed in the dead region formed around the light-receiving portion 14 of the light-receiving element 120.

### Modification Example 2

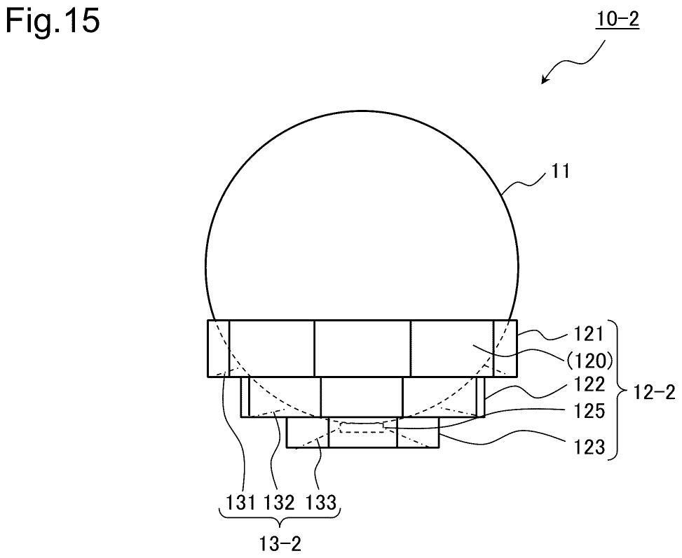

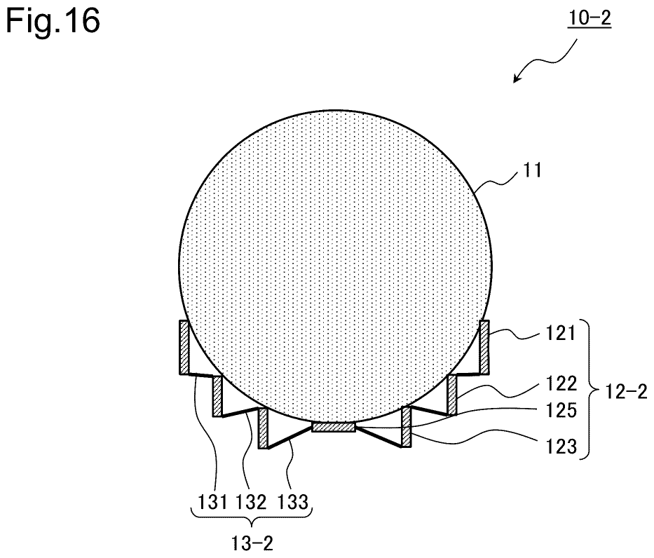

FIGS. 15 to 16 are conceptual diagrams for describing a receiver 10-2 of Modification Example 2. The receiver 10-2 includes a ball lens 11, a light receiver 12-2, and a reflector 13-2. The receiver 10-2 of the present modification example includes a three-stage light receiver 12-2. FIG. 15 is a side view of the receiver 10-2 as viewed from the side. In FIG. 15, the reflector 13-2 hidden by the light receiver 12-2 and a portion of the light receiver 12-2 are indicated by broken lines. FIG. 16 is a cross-sectional view of the receiver 10-2. Hereinafter, description of the ball lens 11 is omitted.

The light receiver 12-2 includes a first light-receiving ring 121, a second light-receiving ring 122, a third light-receiving ring 123, and a light-receiving plate 125. The light receiver 12-2 has a three-stage configuration including a first light-receiving ring 121, a second light-receiving ring 122, and a third light-receiving ring 123. The number of stages of the light receiver 12 may be four or more. The first light-receiving ring 121, the second light-receiving ring 122, and the third light-receiving ring 123 are including a plurality of light-receiving elements 120. The light-receiving plate 125 includes a single light-receiving element 120. The light-receiving plate 125 may include a plurality of light-receiving elements 120.

The light-receiving elements 120 constituting the first light-receiving ring 121, the second light-receiving ring 122, and the third light-receiving ring 123 are arranged in an annular shape with their light-receiving surfaces facing inward. The diameter of the ring formed by the second light-receiving ring 122 is smaller than the diameter of the ring formed by the first light-receiving ring 121. The diameter of the ring formed by the third light-receiving ring 123 is smaller than the diameter of the ring formed by the second light-receiving ring 122. The plurality of light-receiving elements 120 constituting the first light-receiving ring 121 is arranged in an annular shape such that there is no gap between the light-receiving elements 120 adjacent to each other. The plurality of light-receiving elements 120 constituting the second light-receiving ring 122 is arranged in an annular shape such that there is no gap between the light-receiving elements 120 adjacent to each other. The plurality of light-receiving elements 120 constituting the third light-receiving ring 123 is arranged in an annular shape such that there is no gap between the light-receiving elements 120 adjacent to each other.

As illustrated in FIGS. 15 to 16, the diameter of the ring formed by the first light-receiving ring 121 is larger than the diameter of the ring formed by the second light-receiving ring 122. In addition, the diameter of the ring formed by the second light-receiving ring 122 is larger than the diameter of the ring formed by the third light-receiving ring 123. The diameter of the ring formed by the first light-receiving ring 121, the second light-receiving ring 122, and the third light-receiving ring 123 is smaller than the diameter of the ball lens 11. The first light-receiving ring 121, the second light-receiving ring 122, and the third light-receiving ring 123 are arranged below the ball lens 11. The first light-receiving ring 121, the second light-receiving ring 122, and the third light-receiving ring 123 are arranged so as to be in contact with a portion of the lower part of the ball lens 11. Since the diameter of the ring of the first light-receiving ring 121 is larger than that of the second light-receiving ring 122, the second light-receiving ring 122 is disposed below the first light-receiving ring 121. Since the diameter of the ring of the second light-receiving ring 122 is larger than that of the third light-receiving ring 123, the third light-receiving ring 123 is disposed below the second light-receiving ring 122. The light-receiving plate 125 is disposed at the bottom of the ball lens 11 with the light-receiving surface facing the ball lens 11. The light-receiving plate 125 is disposed inside the ring formed by the third light-receiving ring 123 with the light-receiving surface facing the ball lens 11. In the examples of FIGS. 15 to 16, the light-receiving surface of the light-receiving plate 125 is in contact with the bottom of the ball lens 11. The light-receiving surface of the light-receiving plate 125 may be away from the bottom of the ball lens 11.

The reflector 13-2 is disposed in a gap between the ball lens 11 and the light receiver 12-2. The reflector 13-2 includes a first reflector 131, a second reflector 132, and a third reflector 133. The first reflector 131 is disposed in an annular gap formed between the first light-receiving ring 121 and the second light-receiving ring 122. The second reflector 132 is disposed in an annular gap formed between the second light-receiving ring 122 and the third light-receiving ring 123. The third reflector 133 is disposed in an annular gap formed between the third light-receiving ring 123 and the light-receiving plate 125. In the example of FIGS. 15 to 16, the first reflector 131, the second reflector 132, and the third reflector 133 are annual. The first reflector 131, the second reflector 132, and the third reflector 133 have reflecting surfaces that reflect light signals. The first reflector 131, the second reflector 132, and the third reflector 133 are disposed with their reflecting surfaces facing the ball lens 11.

The first reflector 131 includes a large ring and a small ring. The larger ring formed by the first reflector 131 has the same diameter as the ring of the first light-receiving ring 121. The larger ring is arranged in accordance with the lower ring of the first light-receiving ring 121. The smaller ring formed by the first reflector 131 has the same diameter as the ring of the second light-receiving ring 122. The smaller ring is arranged in accordance with the upper ring of the second light-receiving ring 122. The first reflector 131 fills a gap between the first light-receiving ring 121 and the second light-receiving ring 122. The first reflector 131 reflects the light signal condensed in the gap between the first light-receiving ring 121 and the second light-receiving ring 122.

The second reflector 132 includes a large ring and a small ring. The larger ring formed by the second reflector 132 has the same diameter as the ring of the second light-receiving ring 122. The larger ring is arranged in accordance with the lower ring of the second light-receiving ring 122. The smaller ring formed by the second reflector 132 has the same diameter as the ring of the third light-receiving ring 123. The smaller ring is arranged in accordance with the upper ring of the third light-receiving ring 123. The second reflector 132 fills a gap between the second light-receiving ring 122 and the third light-receiving ring 123. The second reflector 132 reflects the light signal condensed in the gap between the second light-receiving ring 122 and the third light-receiving ring 123.

The third reflector 133 includes a large ring and a small ring. The larger ring formed by the third reflector 133 has the same diameter as the ring of the third light-receiving ring 123. The larger ring is arranged in accordance with the lower ring of the third light-receiving ring 123. The smaller ring formed by the third reflector 133 has a diameter corresponding to the size of the light-receiving plate 125. The smaller ring is arranged in accordance with the size of the light-receiving plate 125. The light-receiving plate 125 is not necessarily circular. Therefore, the smaller ring may be formed in accordance with the outer shape of the light-receiving plate 125. The third reflector 133 fills a gap between the second light-receiving ring 122 and the photoreceptor 145. The third reflector 133 reflects the light signal condensed in the gap between the third light-receiving ring 123 and the photoreceptor 145.

In a case where the size of the ball lens 11 is increased, if the size of the light-receiving element 120 does not change, the light component that does not reach the light-receiving element 120 in the light signal condensed by the ball lens 11 increases. In addition, in a case where the light-receiving element 120 is downsized, if the size of the ball lens 11 does not change, the light components that do not reach the light-receiving element 120 in the light signal condensed by the ball lens 11 increase. In these cases, the light-receiving range of the spatial light signal is narrowed. In a case where the ball lens 11 is enlarged or the light-receiving element 120 is downsized, the light-receiving range of the spatial light signal can be maintained/expanded by increasing the number of stages of the light receiver as in the present modification example. That is, by increasing the number of stages of the light receiver as in the present modification example according to the sizes of the ball lens 11 and the light-receiving element 120, it is possible to receive the spatial light signal arriving from a wider range.

### Modification Example 3

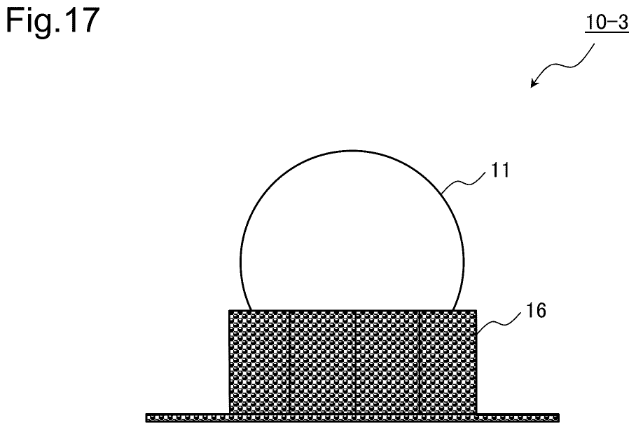

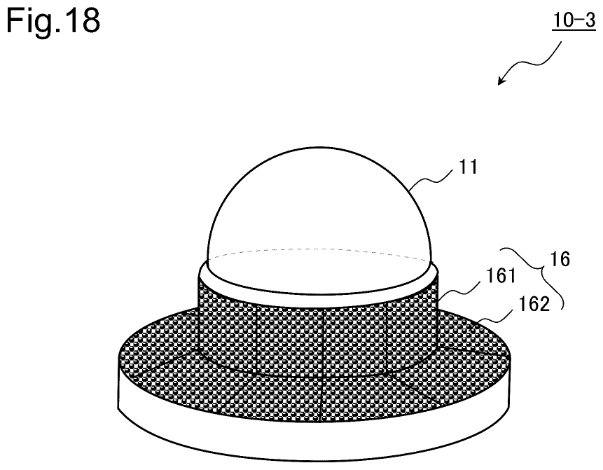

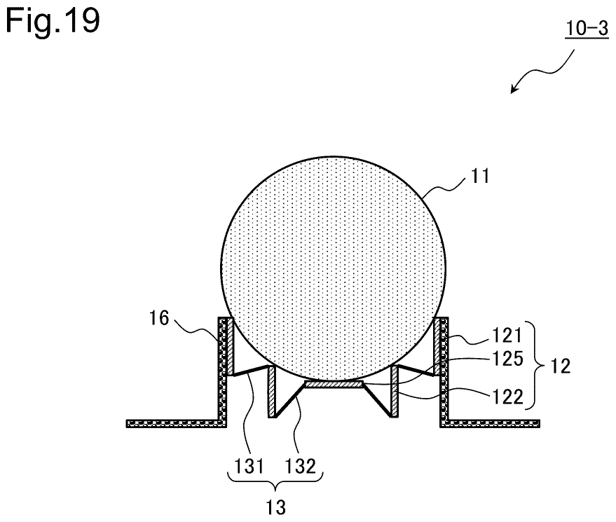

FIGS. 17 to 19 are conceptual diagrams for describing a receiver 10-3 of Modification Example 3. The receiver 10-3 includes a ball lens 11, a light receiver 12, a reflector 13, and a retroreflector 16. The receiver 10-3 of the present modification example includes a two-stage light receiver 12. FIG. 19 is a side view of the receiver 10-3 as viewed from the side. FIG. 18 is a conceptual diagram of the receiver 10-3 viewed from an obliquely upper side. FIG. 19 is a cross-sectional view of the receiver 10-3. Hereinafter, the ball lens 11, the light receiver 12, and the reflector 13 will not be described.

The retroreflector 16 includes a first retroreflector 161 and a second retroreflector 162. The first retroreflector 161 is disposed on an outer side surface of the light receiver 12. The first retroreflector 161 covers the outer side surface of the light receiver 12. The first retroreflector 161 has an annular shape. A retroreflective surface is formed on an outer side surface of the ring formed by the first retroreflector 161. The second retroreflector 162 is disposed in substantially the same plane as the bottom of the ball lens 11. The second retroreflector 162 has a donut-shaped shape with upper and lower surfaces being flat. When the receiver 10-3 is viewed from above, the second retroreflector 162 surrounds the ball lens 11 in a donut shape. A retroreflective surface is formed on the upper surface of the second retroreflector 162. A retroreflective surface may also be formed on the side surface of the second retroreflector 162.

The retroreflective surface is a reflecting surface that retroreflects light incident from a certain direction along an incident direction of the light. The spatial light signal is incident on the retroreflective surfaces of the first retroreflector 161 and the second retroreflector 162. The retroreflective surfaces of the first retroreflector 161 and the second retroreflector 162 retroreflect the incident spatial light signal in an arrival direction of the spatial light signal. In practice, the retroreflective surface does not completely retroreflect the incident spatial light signal toward the arrival direction of the spatial light signal, but retroreflects the spatial light signal with directivity in a certain angular range. The retroreflective surface may be a flat surface or a curved surface. If the retroreflective surface is a curved surface, it is possible to obtain retroreflectivity in a certain angular range in the entire reflecting surface. A communication device (not illustrated) which is a transmission source of the spatial light signal receives the spatial light signal retroreflected by the retroreflective surface of the retroreflector 16 of the receiver 10-3. The communication device of the transmission source can detect that the spatial light signal is received by a communication target device (not illustrated) by receiving the light in which the spatial light signal transmitted from the own device is retroreflected.

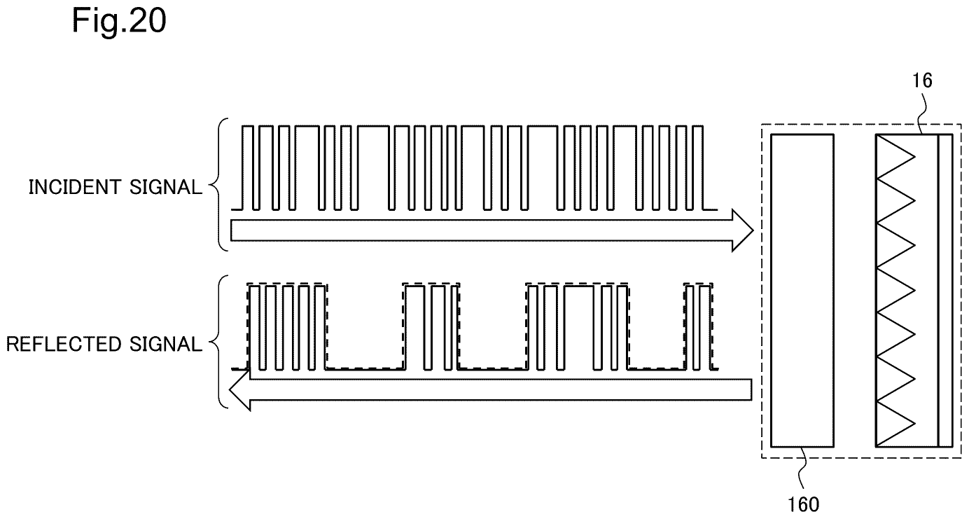

FIG. 20 illustrates an example in which a transmissive modulation element 160 is disposed at the preceding stage of the retroreflective surface of the retroreflector 16. The modulation element 160 is opened and closed in a pattern according to the control of the communication device on which the receiver 10-3 is mounted. A spatial light signal (incident signal) transmitted from a communication target device is incident on the modulation element 160. The spatial light signal having passed through the modulation element 160 is retroreflected by the retroreflective surface of the retroreflector 16. The retroreflected spatial light signal is emitted toward the communication device that is the transmission source of the spatial light signal according to the opening/closing pattern of the modulation element 160. A sufficient difference between the signal frequency of the spatial light signal (incident signal) and the modulation frequency of the modulation element 160 causes the modulated reflected signal to be emitted as illustrated in FIG. 20. By controlling the modulation frequency of the modulation element 160, communication with a communication target device can be performed. In the example of FIG. 20, a signal of a pattern traced by a broken line is emitted. By combining the modulation element 160 and the retroreflector 16, it is possible to communicate with a communication device that is a transmission source of the spatial light signal without providing a transmission system that transmits the laser light.

For example, the modulation element 160 is realized by a twisted nematic (TN)-type liquid crystal element. When the TN-type liquid crystal element is used, a throughput of about 600 bps (bits per second) is expected. A TN-type liquid crystal element can be adopted as long as transmission of a simple code is performed.

For example, the modulation element 160 is realized by a ferroelectric liquid crystal element. The operation speed of the ferroelectric liquid crystal element is on the order of μs (microseconds). Compared with the TN-type liquid crystal element, the ferroelectric liquid crystal element operates at about 1000 times higher speed. Therefore, when the ferroelectric liquid crystal element is used, a refresh rate of about 600 kbps (kilobits per second) is expected. Since the ferroelectric liquid crystal element is a liquid crystal element, it is possible to realize halftone with area gradation. The display itself can be realized with 256 gradations, but since there is demodulation on the reception side, it is expected that a gradation of about four to eight values can be realized. If a gradation of about 4 to 8 values can be realized, a speed increase of about 2 to 3 times can be realized, so that an operation of 1.2 to 1.8 Mpbs can be performed. With such a throughput, an image with low resolution can be transmitted.

For example, the modulation element 160 can be realized by a micro electro mechanical systems (MEMS)-type element. The MEMS-type element controls the passage/shielding of light by moving the shutter in the horizontal direction to shift the positional relationship of the slits. The MEMS-type element operates at several tens of microseconds (las). When the MEMS-type element is used, a throughput of about 100 kbps is expected although the throughput is about 1 order of magnitude slower than that of the ferroelectric liquid crystal. Similarly to the liquid crystal element, the throughput of the MEMS-type element can be improved by using the area gradation.

For example, the modulation element 160 can be implemented by a metamaterial element. The metamaterial element controls light transmittance by utilizing a phase change of vanadium dioxide in response to a temperature change. Vanadium dioxide is an insulating phase (monoclinic crystal) at a phase transition temperature or lower, and changes to a metal phase (tetragonal crystal) at a phase transition temperature or higher. Vanadium dioxide undergoes a phase transition at a high speed at the nano to picosecond level. The metamaterial element can operate at high speed by utilizing a phase change of vanadium dioxide according to a temperature change by a built-in heater. When a metamaterial element is used, a throughput of about 100 Mbps (megabits per second) is expected. Since the metamaterial element is a surface device, it is possible to increase the throughput by 2 to 3 times by multi-leveling.

(Related Art)

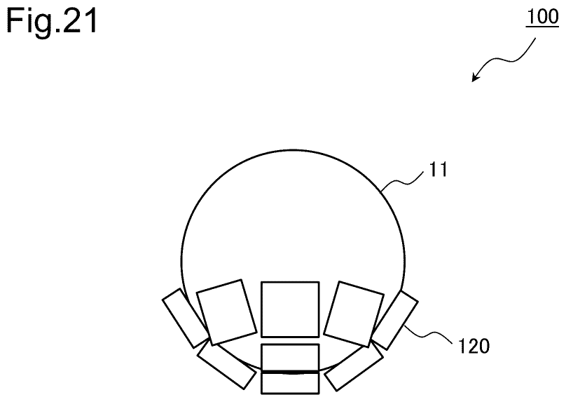

Next, a related art related to the present example embodiment will be described with reference to the drawings. FIG. 21 is a conceptual diagram illustrating an example of a configuration of a receiver 100 of the related art. FIG. 21 is a side view of the receiver 100 as viewed from the side. The receiver 100 includes a ball lens 11 as in the first example embodiment. Furthermore, the receiver 100 includes a plurality of light-receiving elements 120. The plurality of light-receiving elements 120 are arranged on the bottom surface side of the ball lens 11 with the light-receiving surface facing the ball lens 11.

In the case of the related art in FIG. 21, a gap is formed between the light-receiving elements 120 adjacent to each other. The light signal condensed at the position of the gap is not received by the light-receiving element 120. Therefore, in the receiver 100 of the related art, the light reception loss occurs by the amount of the light signal condensed at the position of the gap. If the light-receiving element 120 is further disposed at the position of the gap, the light reception loss can be reduced. However, more light-receiving elements 120 are required for the additionally arranged light-receiving elements 120.

In the configuration of the example embodiment, the plurality of light-receiving elements are arranged in an annular shape to form the light receiver, so that there is no gap between the adjacent light-receiving elements. In addition, in the configuration of the present example embodiment, since the reflector is disposed in the gap between the plurality of light receivers, there is no gap between the light receivers. Therefore, according to the configuration of the present example embodiment, it is possible to eliminate a gap that can be left between the plurality of light-receiving elements without adding a light-receiving element.

As described above, the receiving device of the present example embodiment includes the ball lens, the light receiver, the reflector, and the receiving circuit. The ball lens, the light receiver, and the reflector constitute a receiver. The ball lens is placed on a ring formed by the light-receiving ring. The light receiver includes a first light-receiving ring, a second light-receiving ring, and a light-receiving plate. The first light-receiving ring includes a plurality of light-receiving elements arranged in an annular shape. The second light-receiving ring includes a plurality of light-receiving elements arranged in an annular shape with a diameter smaller than that of the first light-receiving ring. The plurality of light-receiving elements constituting the first light-receiving ring and the second light-receiving ring are arranged with the light-receiving surface facing the inside of the ring formed by the light-receiving rings. The light-receiving plate includes at least one light-receiving element. The light-receiving element included in the light-receiving plate is disposed inside the ring formed by the light-receiving ring with a light-receiving surface facing the ball lens placed on the light-receiving ring. The reflector includes a first reflector and a second reflector. The first reflector is disposed in a gap formed between the first light-receiving ring and the second light-receiving ring. The second reflector is disposed in a gap formed between the second light-receiving ring and the light-receiving plate. The receiving circuit obtains a signal received by the receiver. The receiving circuit decodes the acquired signal.

The receiving device according to the present example embodiment condenses light signals arriving from various directions by a ball lens. The light signal condensed by the ball lens is condensed on the first light-receiving ring, the second light-receiving ring, or the reflector. The light signals condensed in the first light-receiving ring and the second light-receiving ring are received by the light-receiving elements constituting these light-receiving rings. The light signal condensed on the reflector is reflected by the reflecting surface of the reflector, and received by the light-receiving element constituting one of the light-receiving rings. The light signal received by the light-receiving element is converted into an electric signal and received by the receiving circuit. Therefore, according to the receiving device of the present example embodiment, light signals arriving from various directions can be efficiently received.

A receiver according to an aspect of the present example embodiment includes a reflecting body. The reflecting body is disposed in a dead region formed between the light-receiving regions of the light-receiving elements adjacent to each other with the reflecting surface facing the ball lens. According to the present aspect, the light signal condensed in the dead region is reflected toward the light-receiving region of one of the light-receiving elements by the reflecting surface of the reflecting body arranged in the dead region. Therefore, according to the present aspect, a light signal can be received more efficiently.

In one aspect of the present example embodiment, the light-receiving ring includes a first light-receiving ring, a second light-receiving ring, and a third light-receiving ring. The first light-receiving ring includes a plurality of light-receiving elements arranged in an annular shape. The second light-receiving ring includes a plurality of light-receiving elements arranged in an annular shape with a diameter smaller than that of the first light-receiving ring. The third light-receiving ring includes a plurality of light-receiving elements arranged in an annular shape with a diameter smaller than that of the second light-receiving ring. The reflector includes a first reflector, a second reflector, and a third reflector. The first reflector is disposed in a gap formed between the first light-receiving ring and the second light-receiving ring. The second reflector is disposed in a gap formed between the second light-receiving ring and the third light-receiving ring. The third reflector is disposed in a gap formed between the third light-receiving ring and the light-receiving plate. The receiver of the present aspect has a three-stage light-receiving ring. Therefore, according to the present aspect, by increasing the size of the ball lens, the light-receiving range of the spatial light signal can be expanded. The number of stages of the light-receiving ring may be four or more.

A receiver according to an aspect of the present example embodiment includes a retroreflector. The retroreflector has a retroreflective surface. The retroreflector is arranged along the outer periphery of the light-receiving ring with the retroreflective surface facing the arrival direction of the spatial light signal. According to the present aspect, the spatial light signal retroreflected by the retroreflector returns toward the transmission source of the spatial light signal. Therefore, according to the present aspect, the reception of the spatial light signal can be notified to the other communication device as the communication target.

A receiver according to an aspect of the present example embodiment includes a modulation element. The modulation element is disposed at a preceding stage of the retroreflector. The modulation element modulates the incident spatial light signal. In the present aspect, the spatial light signal incident on the retroreflector is modulated by the modulation element and then sent back to the transmission source of the spatial light signal. The modulation pattern of the modulation element can be arbitrarily set. Therefore, according to the present aspect, it is possible to transmit a desired spatial light signal to another communication device as a communication target with a simple configuration.

In one aspect of the present example embodiment, the receiving circuit detects the arrival direction of the spatial light signal that is the source of the light signal according to the position of the light-receiving element that has received the light signal. According to the present aspect, the arrival direction of the spatial light signal can be specified according to the position of the light-receiving element that has received the light signal.

### Second Example Embodiment

Next, a communication device according to a second example embodiment will be described with reference to the drawings. The communication device of the present example embodiment has a configuration in which a receiving device and a transmitting device are combined. The receiving device has the configuration of the first example embodiment. The transmitting device transmits a spatial light signal. Hereinafter, an example of a transmitting device including a phase modulation-type spatial light modulator will be described. Note that the communication device of the present example embodiment may include a transmitting device including a light transmission function rather than a phase modulation-type spatial light modulator.

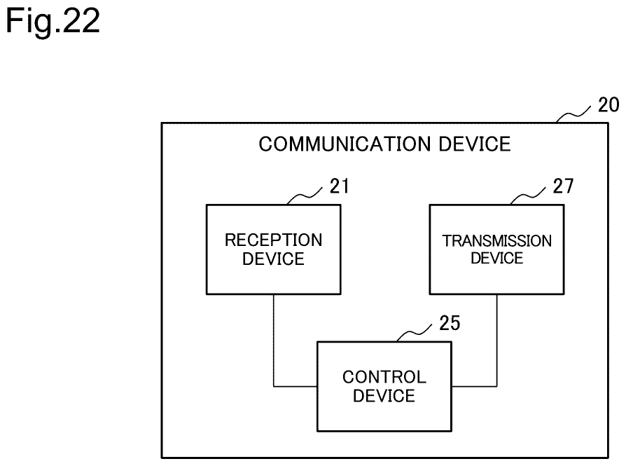

FIG. 22 is a conceptual diagram illustrating an example of a configuration of the communication device 20 according to the present example embodiment. The communication device 20 includes a receiving device 21, a control device 25, and a transmitting device 27. The communication device 20 transmits and receives spatial light signals to and from an external communication target. Therefore, an opening or a window for transmitting and receiving a spatial light signal is formed in the communication device 20.

The receiving device 21 is the receiving device of the first example embodiment. The receiving device 21 receives a spatial light signal transmitted from a communication target (not illustrated). The receiving device 21 converts the received spatial light signal into an electric signal. The receiving device 21 outputs the converted electric signal to the control device 25.

The control device 25 acquires a signal output from the receiving device 21. The control device 25 executes processing according to the acquired signal. The processing executed by the control device 25 is not particularly limited. The control device 25 outputs a control signal for transmitting a light signal corresponding to the executed processing to the transmitting device 27. For example, the control device 25 executes processing based on a predetermined condition according to information included in the signal received by the receiving device 21. For example, the control device 25 executes processing designated by the administrator of the communication device 20 according to information included in the signal received by the receiving device 21.

The transmitting device 27 acquires a control signal from the control device 25. The transmitting device 27 projects a spatial light signal according to the control signal. The spatial light signal projected from the transmitting device 27 is received by a communication target (not illustrated) of a transmission destination of the spatial light signal. For example, the transmitting device 27 includes a phase modulation-type spatial light modulator. Furthermore, the transmitting device 27 may have a light transmission function rather than a phase modulation-type spatial light modulator.

[Transmitting Device]

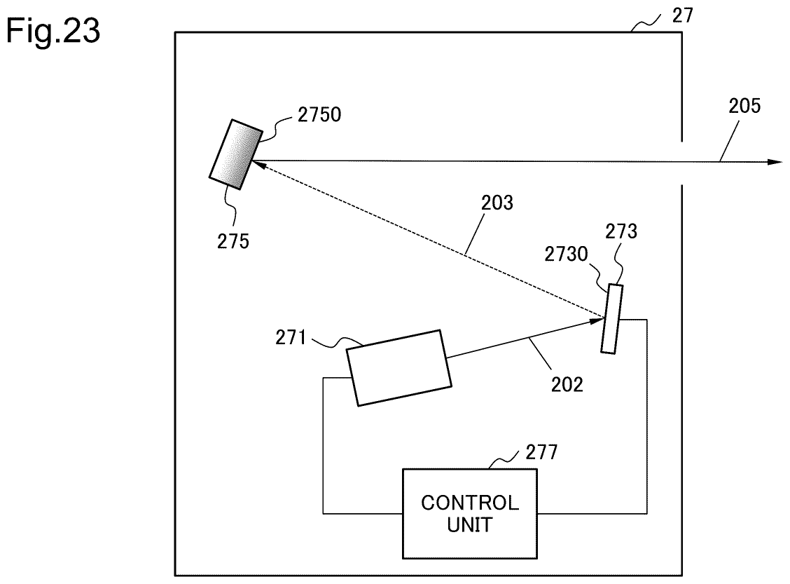

FIG. 23 is a conceptual diagram illustrating an example of a configuration of the transmitting device 27. The transmitting device 27 includes a light source 271, a spatial light modulator 273, a curved minor 275, and a control unit 277. FIG. 23 is a side view of the internal configuration of the transmitting device 27 as viewed from the lateral direction. FIG. 23 is conceptual, and does not accurately represent the positional relationship between the components, the traveling direction of light, and the like.

The light source 271 emits laser light in a predetermined wavelength band under the control of the control unit 277. The wavelength of the laser light emitted from the light source 271 is not particularly limited, and may be selected according to the application. For example, the light source 271 emits laser light in the visible or infrared wavelength band. For example, in the case of near infrared rays of 800 to 900 nanometers (nm), the laser class can be given, and thus the sensitivity can be improved by about 1 digit as compared with other wavelength bands. For example, a high-output laser light source can be used for infrared rays in a wavelength band of 1.55 micrometers (m). As an infrared laser light source in a wavelength band of 1.55 μm, an aluminum gallium arsenide phosphorus (AlGaAsP)-based laser light source, an indium gallium arsenide (InGaAs)-based laser light source, or the like can be used. The longer the wavelength of the laser light is, the larger the diffraction angle can be made and the higher the energy can be set. The light source 271 includes a lens that enlarges the laser light in accordance with the size of the modulation region set in a modulation unit 2730 of the spatial light modulator 273. The light source 271 emits light 202 enlarged by the lens. The light 202 emitted from the light source 271 travels toward the modulation unit 2730 of the spatial light modulator 273.

The spatial light modulator 273 includes a modulation unit 2730. A modulation region is set in the modulation unit 2730. In the modulation region of the modulation unit 2730, a pattern (also referred to as a phase image) corresponding to the image displayed by projection light 205 is set according to the control of control unit 277. The modulation unit 2730 is irradiated with the light 202 emitted from the light source 271. The light 202 incident on the modulation unit 2730 is modulated according to a pattern (phase image) set in the modulation unit 2730. The modulated light 203 modulated by the modulation unit 2730 travels toward the reflecting surface 2750 of the curved mirror 275.

For example, the spatial light modulator 273 is realized by a spatial light modulator using ferroelectric liquid crystal, homogeneous liquid crystal, vertical alignment liquid crystal, or the like. For example, the spatial light modulator 273 can be realized by liquid crystal on silicon (LCOS). Furthermore, the spatial light modulator 273 may be realized by a micro electro mechanical system (MEMS). In the phase modulation-type spatial light modulator 273, the energy can be concentrated on the portion of the image by operating to sequentially switch the portion on which the projection light 205 is projected. Therefore, in the case of using the phase modulation-type spatial light modulator 273, if the output of the light source 271 is the same, the image can be displayed brighter than other methods.

The modulation region of the modulation unit 2730 is divided (also referred to as tiled) into a plurality of regions. For example, the modulation region of the modulation unit 2730 is divided into rectangular regions (also referred to as tiles) having a desired aspect ratio. A phase image is assigned to each of the plurality of tiles set in the modulation region of the modulation unit 2730. Each of the plurality of tiles includes a plurality of pixels. A phase image corresponding to a projected image is set to each of the plurality of tiles. The phase images set to the plurality of tiles may be the same or different.

A phase image is tiled to each of the plurality of tiles assigned to the modulation region of the modulation unit 2730. For example, a phase image generated in advance is set in each of the plurality of tiles. When the modulation unit 2730 is irradiated with the light 202 in a state where the phase images are set for the plurality of tiles, the modulated light 203 that forms an image corresponding to the phase image of each tile is emitted. As the number of tiles set in the modulation unit 2730 increases, a clear image can be displayed. However, when the number of pixels of each tile decreases, the resolution decreases. Therefore, the size and number of tiles set in the modulation region of the modulation unit 2730 are set according to the application.

The curved mirror 275 is a reflecting mirror having a curved reflecting surface 2750. The reflecting surface 2750 of the curved mirror 275 has a curvature corresponding to the projection angle of the projection light 205. The reflecting surface 2750 of the curved mirror 275 may be a curved surface. In the example of FIG. 34, the reflecting surface 2750 of the curved mirror 275 has a shape of a side surface of a cylinder. For example, the reflecting surface 2750 of the curved mirror 275 may be a free-form surface or a spherical surface. For example, the reflecting surface 2750 of the curved mirror 275 may have a shape in which a plurality of curved surfaces are combined instead of a single curved surface. For example, the reflecting surface 2750 of the curved mirror 275 may have a shape in which a curved surface and a flat surface are combined.

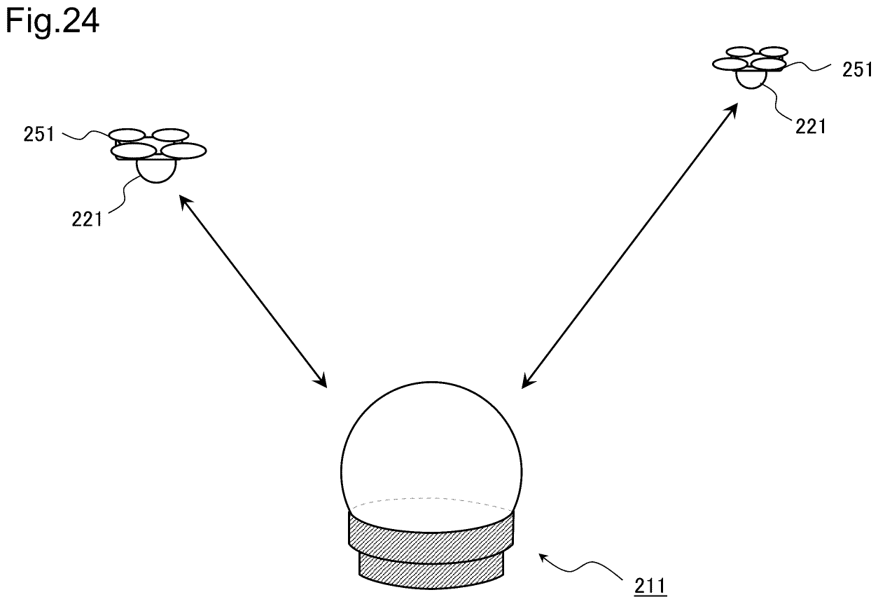

The curved mirror 275 is disposed with the reflecting surface 2750 facing the modulation unit 2730 of the spatial light modulator 273. The curved mirror 275 is disposed on an optical path of the modulated light 203. The reflecting surface 2750 is irradiated with the modulated light 203 modulated by the modulation unit 2730. The light (projection light 205) reflected by the reflecting surface 2750 is enlarged at an enlargement ratio corresponding to the curvature of the reflecting surface 2750 and projected. In the case of the example of FIG. 24, the projection light 205 is enlarged along the horizontal direction (the direction perpendicular to the paper surface of FIG. 24) according to the curvature of the irradiation range of the modulated light 203 on the reflecting surface 2750 of the curved mirror 275. Further, the projection light 205 is also enlarged in the vertical direction (the vertical direction in the sheet of FIG. 24) as it goes away from the transmitting device 27.

For example, a shield (not illustrated) may be disposed between the spatial light modulator 273 and the curved mirror 275. That is, a shield may be arranged on an optical path of the modulated light 203 modulated by the modulation unit 2730 of the spatial light modulator 273. The shield is a frame that shields unnecessary light components included in the modulated light 203 and defines an outer edge of a display area of the projection light 205. For example, the shield is an aperture in which a slit-shaped opening is formed in a portion through which light forming a desired image passes. The shield passes light that forms a desired image and shields unnecessary light components. For example, the shield shields 0th-order light or a ghost image included in the modulated light 203. Details of the shield will not be described.

The transmitting device 27 may be provided with a projection optical system including a Fourier transform lens, a projection lens, and the like instead of the curved minor 275. Furthermore, the transmitting device 27 may be configured to directly project the light modulated by the modulation unit 2730 of the spatial light modulator 273 without including the curved mirror 275 or the projection optical system.

The control unit 277 controls the light source 271 and the spatial light modulator 273. For example, the control unit 277 is realized by a microcomputer including a processor and a memory. The control unit 277 sets a phase image corresponding to the projected image in the modulation unit 2730 in accordance with the aspect ratio of tiling set in the modulation unit 2730 of the spatial light modulator 273. For example, the control unit 277 sets, in the modulation unit 2730, a phase image corresponding to an image according to a use such as image display, communication, or distance measurement. The phase image of the projected image may be stored in advance in a storage unit (not illustrated). The shape and size of the image to be projected are not particularly limited.

The control unit 277 controls the spatial light modulator 273 such that a parameter that determines a difference between a phase of the light 202 emitted to the modulation unit 2730 of the spatial light modulator 273 and a phase of the modulated light 203 reflected by the modulation unit 2730 changes. For example, the parameter is a value related to optical characteristics such as a refractive index and an optical path length. For example, the control unit 277 adjusts the refractive index of the modulation unit 2730 by changing the voltage applied to the modulation unit 2730 of the spatial light modulator 273. The phase distribution of the light 202 emitted to the modulation unit 2730 of the phase modulation-type spatial light modulator 273 is modulated according to the optical characteristics of the modulation unit 2730. Note that the method of driving the spatial light modulator 273 by the control unit 277 is determined according to the modulation scheme of the spatial light modulator 273.

The control unit 277 drives the light source 271 in a state where the phase image corresponding to the image to be displayed is set in the modulation unit 2730. As a result, the light 202 emitted from the light source 271 is emitted to the modulation unit 2730 of the spatial light modulator 273 in accordance with the timing at which the phase image is set in the modulation unit 2730 of the spatial light modulator 273. The light 202 emitted to the modulation unit 2730 of the spatial light modulator 273 is modulated by the modulation unit 2730 of the spatial light modulator 273. The modulated light 203 modulated by the modulation unit 2730 of the spatial light modulator 273 is emitted toward the reflecting surface 2750 of the curved mirror 275.

For example, the curvature of the reflecting surface 2750 of the curved mirror 275 included in the transmitting device 27 and the distance between the spatial light modulator 273 and the curved mirror 275 are adjusted, and the projection angle of the projection light 205 is set to 180 degrees. By using two transmitting devices 27 configured as described above, the projection angle of the projection light 205 can be set to 360 degrees. Furthermore, if a portion of the modulated light 203 is folded back with a plane mirror or the like inside the transmitting device 27, and the projection light 205 is projected in two directions, the projection angle of the projection light 205 can be set to 360 degrees. For example, the transmitting device 27 configured to project projection light in a direction of 360 degrees and the receiving device 21 configured to receive a spatial light signal arriving from a direction of 360 degrees are combined. With such a configuration, it is possible to realize a communication device that transmits a spatial light signal in a direction of 360 degrees and receives a spatial light signal arriving from a direction of 360 degrees.

### Application Example

Next, an application example of the communication device 20 of the present example embodiment will be described with reference to the drawings. Hereinafter, three application examples (Application Examples 1 to 3) will be described. In the following application example, an example in which a communication device (master unit) on the management side/control side and a communication device (slave unit) on the managed side/controlled side transmit and receive a spatial light signal will be described. Any of the communication devices has the same configuration as the communication device according to the second example embodiment.

### Application Example 1

FIG. 24 is a conceptual diagram for describing Application Example 1. The present application example is an example in which a spatial light signal is transmitted and received between a communication device installed in a management station (not illustrated) on the ground and a communication device mounted on a drone 251 flying in the sky. In the present application example, an example in which the communication device (master unit 211) of the master unit is arranged in the management station and the communication device (slave unit 221) of the slave unit is mounted on the drone 251 will be described. In the present application example, a communication system is formed by the master unit 211 of the management station and the slave unit 221 mounted on the drone 251.

In the management station, a communication device (master unit 211) on the management side is disposed. For example, the master unit 211 is disposed on a rooftop of a building of the management station. The master unit 211 is disposed such that the light receiver is positioned below the ball lens. The master unit 211 receives spatial light signals arriving from all upward directions. In order to communicate with the drone 251 flying in a wide range, the master unit 211 is equipped with a ball lens larger than the slave unit 221. For example, the receiver (FIGS. 15 to 16) of Modification Example 2 according to the first example embodiment is mounted in the master unit 211. According to the configuration of the second modification example, the light-receiving range of the spatial light signal can be expanded by increasing the number of light receivers according to the increase in size of the ball lens. Since the master unit 211 is installed on the ground, there are few restrictions on the size of the master unit, and the master unit can be increased in size.

The communication device (slave unit 221) on the managed side is mounted on the drone 251. For example, the drone 251 is equipped with a camera that captures an image of the surroundings and a sensor that measures a physical quantity of the surroundings. The slave unit 221 is mounted below the drone 251. The slave unit 221 is disposed such that the light receiver is positioned above the ball lens. The slave unit 221 receives a spatial light signal arriving from below. The slave unit 221 is equipped with a ball lens smaller than that of the master unit 211. For example, in order to reduce the weight load of the drone 251, the receiver (FIGS. 17 to 19) of Modification Example 3 according to the first example embodiment is mounted on the slave unit 221. The receiver of Modification Example 3 retroreflects the spatial light signal transmitted from the master unit 211 toward the master unit 211. For example, the slave unit 221 may be a receiver (FIG. 20) including a modulation element. In the case of the receiver including the modulation element, the spatial light signal transmitted from the master unit 211 can be retroreflected after being modulated, so that the transmission function can be simplified.

According to the present application example, by using the large master unit 211, omnidirectional communication is realized between the small slave unit 221 mounted on the drone 251 flying in a wide range and the master unit 211. That is, according to the present application example, communication using the spatial light signal becomes possible between the drone 251 flying at an arbitrary position in the sky and the management station on the ground. As a result, according to the present application example, it is possible to realize a system in which the management station on the ground controls the flight of the drone 251. Furthermore, according to the present application example, it is possible to realize a system that utilizes information condensed by the drone 251 in real time.

### Application Example 2

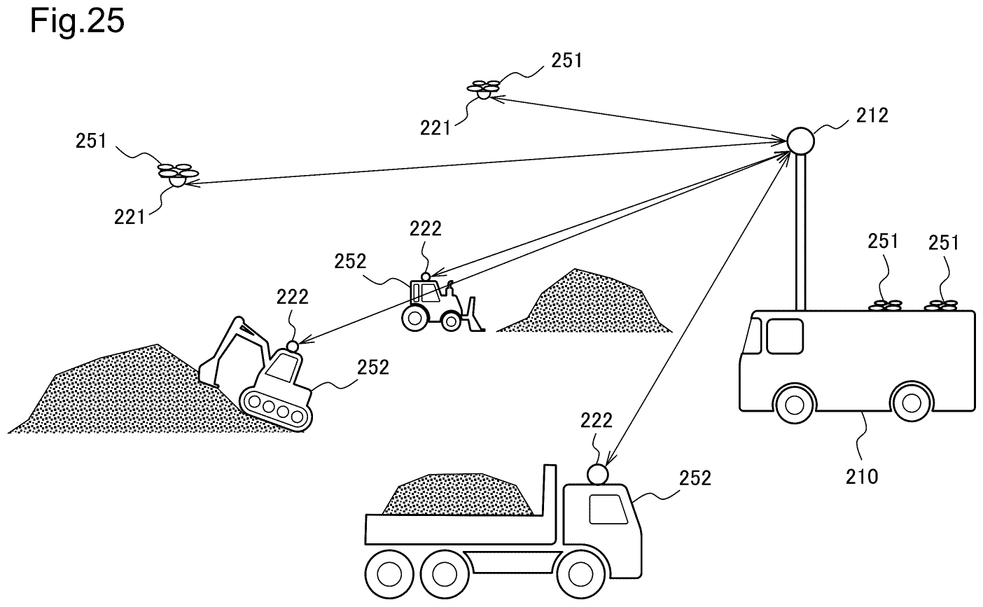

FIG. 25 is a conceptual diagram for describing Application Example 2. The present application example is an example in which a spatial light signal is transmitted and received between a communication device mounted on a plurality of construction vehicles 252 operating at a construction site and a communication device installed in a control vehicle 210 that controls the construction vehicles 252. In the present application example, the communication device (master unit 212) of the master unit is disposed in the control vehicle 210, and the communication device (slave unit 222) of the slave unit is mounted in the construction vehicle 252. In the present application example, a communication system is formed by the master unit 212 of the control vehicle 210 and the slave unit 222 mounted on the construction vehicle 252.

In addition, in the present application example, the drone 251 of Modification Example 1 flies above the construction site. The drone 251 is controlled by the control vehicle 210, and acts as a repeater when a shielding object enters between the master unit 212 of the control vehicle 210 and the slave unit 222 of the construction vehicle 252. In the example of FIG. 25, a power feeding device (not illustrated) capable of feeding power to the drone 251 is mounted on the upper part of the control vehicle 210. For example, the drone 251 captures an image of a construction site from above or performs distance measurement.

The control vehicle 210 is parked at or near a construction site. In the control vehicle 210, a communication device (master unit 212) on the control side is disposed. For example, the master unit 212 is disposed on a pillar installed on an upper part of the control vehicle 210. It is preferable that the height of the upper pillar of the control vehicle 210 is as high as possible so that the entire area of the construction site can be set to the communication range. For example, the master unit 212 may be installed at a construction site or above a pillar installed near the construction site without using the control vehicle 210. The master unit 212 is connected to a control system (not illustrated) that controls the construction vehicle 252 operating at a construction site.

The master unit 212 is disposed such that the position of the light receiver with respect to the ball lens is located on the opposite side of the construction site. The master unit 212 receives the spatial light signal arriving from the direction of the construction site. The light-receiving direction of the master unit 212 is set such that the flying range of the drone 251 is included in the communication range. In order to communicate with the construction vehicle 252 moving in a wide range at a construction site, the master unit 212 is mounted with a ball lens larger than the slave unit 222. For example, the receiver (FIGS. 15 to 16) of Modification Example 2 according to the first example embodiment is mounted in the master unit 212. According to the configuration of the second modification example, the light-receiving range of the spatial light signal can be expanded by increasing the number of light receivers according to the increase in size of the ball lens. Since master unit is installed on the ground, there are few restrictions on the size of the master unit 212, and the master unit can be increased in size.

A plurality of construction vehicles 252 operate at a construction site. A plurality of construction vehicles 252 operate under control of a control system connected to the master unit 212. A communication device (slave unit 222) on the controlled side is mounted on the construction vehicle 252. For example, the construction vehicle 252 is equipped with an automatic driving device (not illustrated) that operates the construction vehicle 252 according to a spatial light signal transmitted from the master unit 212.

The slave unit 222 is mounted on an upper side of the construction vehicle 252. The slave unit 222 is disposed such that the light receiver is positioned below the ball lens. The slave unit 222 receives a spatial light signal arriving from above. The slave unit 222 is equipped with a ball lens smaller than that of the master unit 212. For example, the receiver (FIGS. 17 to 19) of Modification Example 3 according to the first example embodiment is mounted in the slave unit 222. The receiver of Modification Example 3 retroreflects the spatial light signal transmitted from the master unit 212 toward the master unit 212. For example, the slave unit 222 may be a receiver (FIG. 20) including a modulation element. In the case of the receiver including the modulation element, the spatial light signal transmitted from the master unit 212 can be retroreflected after being modulated, so that the transmission function can be simplified.

For example, the control device connected to the master unit 212 uses information such as image information and distance measurement information acquired by the drone 251 to specify the position of the slave unit 222 whose communication is interrupted. The control device selects the drone 251 used for relaying the spatial light signal according to the specified position of the slave unit 222. The control device can transmit the spatial light signal to the slave unit 222 whose communication is interrupted by relaying the selected drone 251.

According to the present application example, the construction vehicle 252 operating at the construction site can be controlled by using the master unit 212 mounted on the control vehicle 210. In addition, according to the present application example, it is possible to realize a system that automatically operates the construction vehicle 252 operating at the construction site while utilizing the information condensed by the drone 251.

### Application Example 3

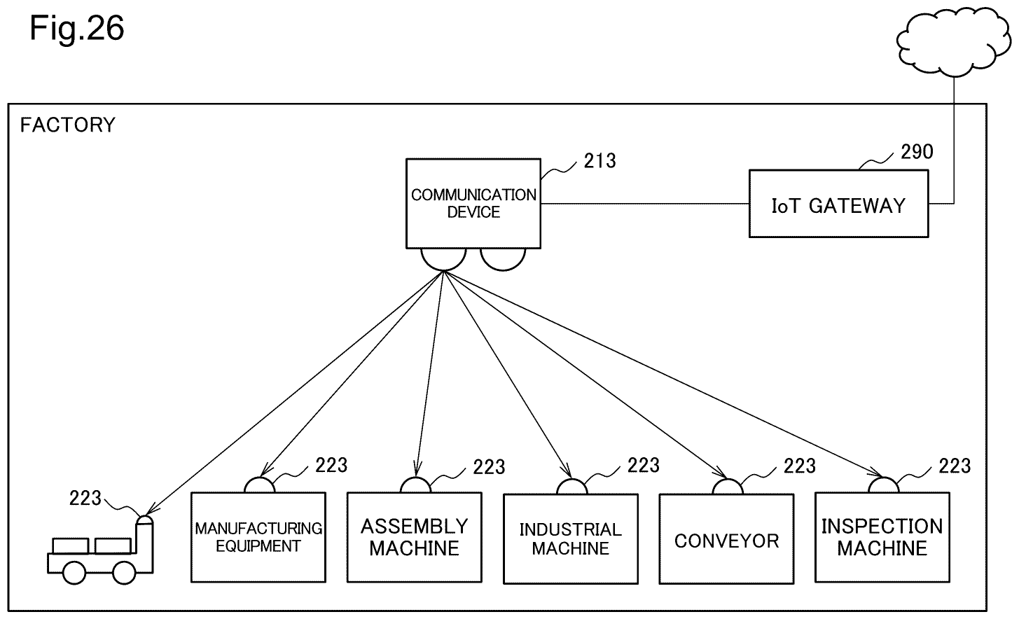

FIG. 26 is a conceptual diagram for describing Application Example 3. The present application example is an example in which a spatial light signal is transmitted and received between a communication device mounted on a device operating in a factory and a communication device connected to a management system (not illustrated) that manages these manufacturing devices. In the present application example, the communication device (master unit 213) of the master unit is disposed on the ceiling of the factory, and the communication device (slave unit 223) of the slave unit is mounted on a plurality of devices. A plurality of master units 213 may be disposed inside the factory. For example, the plurality of master units 213 are connected so as to be able to perform high-speed communication. In the present application example, a communication system is formed by the master unit 213 installed on the ceiling and the slave units 223 mounted on a plurality of devices.

The master unit 213 is connected to an IoT (Internet of Things) gateway 290. The IoT gateway 290 has a router function of relaying data condensed by a plurality of devices and relaying data transmitted from a management system. The IoT gateway 290 is connected to a management system constructed in a cloud or a server via the Internet. The communication load can be reduced by processing the enormous data condensed by the plurality of devices by the IoT gateway 290 and then transmitting the data to the management system. The management system may be constructed in a terminal device inside the factory.

The master unit 213 is disposed on a ceiling where a plurality of devices can be looked down. As long as spatial light signals can be exchanged with a plurality of devices, the position where the master unit 213 is disposed is not limited. For example, the master unit 213 may be installed on a wall of a factory or the like. The master unit 213 is disposed such that the position of the light receiver with respect to the ball lens is located on the ceiling side. The master unit 213 receives spatial light signals transmitted from a plurality of devices installed inside the factory. Further, the master unit 213 transmits a spatial light signal to a plurality of devices installed inside the factory. In order to communicate with devices arranged in a wide range inside the factory, a ball lens larger than the slave unit 223 is mounted on the master unit 213. For example, the receiver (FIGS. 15 to 16) of Modification Example 2 according to the first example embodiment is mounted in the master unit 213. According to the configuration of the second modification example, the light-receiving range of the spatial light signal can be expanded by increasing the number of light receivers according to the increase in size of the ball lens.

A plurality of devices operates inside the factory. In the example of FIG. 26, a conveyance robot, manufacturing equipment, an assembly machine, an industrial machine, a conveyor, and an inspection machine are arranged. Each of the plurality of devices is equipped with a communication device (slave unit 223) on the managed side. The slave unit 223 is mounted on the upper side of the device. The slave unit 223 is disposed such that the light receiver is positioned below the ball lens. The slave unit 223 receives the spatial light signal transmitted from the master unit 213 above. The slave unit 223 transmits the spatial light signal toward the master unit 213 above. The slave unit 223 is equipped with a ball lens smaller than that of the master unit 213. For example, the receiver (FIGS. 17 to 19) of Modification Example 3 according to the first example embodiment is mounted in the slave unit 223. The receiver of Modification Example 3 retroreflects the spatial light signal transmitted from the master unit 213 toward the master unit 213. For example, the slave unit 223 may be a receiver (FIG. 20) including a modulation element. In the case of the receiver including the modulation element, the spatial light signal transmitted from the master unit 213 can be retroreflected after being modulated, so that the transmission function can be simplified.

For example, a management system connected to the master unit 213 uses data condensed by a plurality of devices to manage operation statuses of the devices. For example, the management system displays the operating status of the device operating inside the factory on a screen of a terminal device (not illustrated) handled by the administrator. For example, the management system transmits a control signal to the devices according to the grasped operation state.

According to the present application example, the device operating inside the factory can be managed by using the master unit 213 installed inside the factory. According to the present application example, since the spatial light signal is exchanged between the master unit 213 and the slave unit 223, the wiring can be omitted. Unlike wireless communication, communication using a spatial light signal is less likely to be restricted in the number of devices that can be connected at the same time. Communication using a spatial light signal is less susceptible to noise inside a factory. In addition, according to the present application example, it is possible to realize a system that automatically controls a plurality of devices operating in a factory while utilizing data condensed by a plurality of devices.

As described above, the communication device according to the present example embodiment includes the receiving device, the transmitting device, and the control device. The receiving device includes a ball lens, a light receiver, a reflector, and a receiving circuit. The ball lens, the light receiver, and the reflector constitute a receiver. The ball lens is placed on a ring formed by the light-receiving ring. The light receiver includes a light-receiving ring and a light-receiving plate. The light-receiving ring includes a plurality of light-receiving elements arranged in an annular shape. The plurality of light-receiving elements constituting the light-receiving ring are arranged with a light-receiving surface facing an inner side of the ring formed by the light-receiving ring. The light-receiving plate includes at least one light-receiving element. The light-receiving element included in the light-receiving plate is disposed inside the ring formed by the light-receiving ring with a light-receiving surface facing the ball lens placed on the light-receiving ring. The reflector is disposed in a gap formed between the light-receiving ring and the light-receiving plate. The receiving circuit obtains a signal received by the receiver. The receiving circuit decodes the acquired signal. The transmitting device transmits a spatial light signal. The control device acquires a signal based on a spatial light signal from another communication device received by the receiving device. The control device executes processing according to the acquired signal. The control device causes the transmitting device to transmit a spatial light signal corresponding to the executed processing.

The communication device according to the present example embodiment condenses light signals arriving from various directions by a ball lens. The light signal condensed by the ball lens is condensed on the light-receiving ring or the reflector. The light signal condensed on the light-receiving ring is received by the light-receiving element constituting the light-receiving ring. The light signal condensed on the reflector is reflected by the reflecting surface of the reflector, and received by the light-receiving element constituting one of the light-receiving rings. Therefore, according to the present example embodiment, communication using a spatial light signal can be performed among a plurality of communication devices arranged at various positions.

A communication system according to an aspect of the present example embodiment includes a plurality of the above-described communication devices. In a communication system, a plurality of communication devices are arranged to transmit and receive spatial light signals to and from each other. According to the present aspect, it is possible to realize a communication network that transmits and receives a spatial light signal.

### Third Example Embodiment

Next, a receiver according to a third example embodiment will be described with reference to the drawings. The receiver of the present example embodiment has a simplified configuration of the receiver of the first example embodiment.

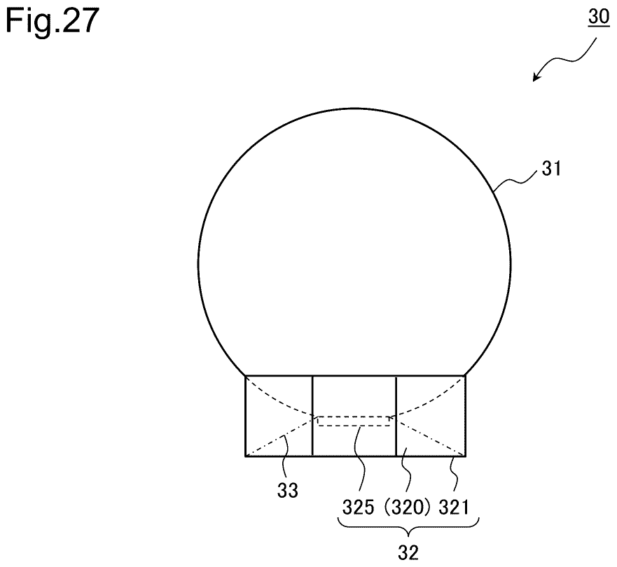

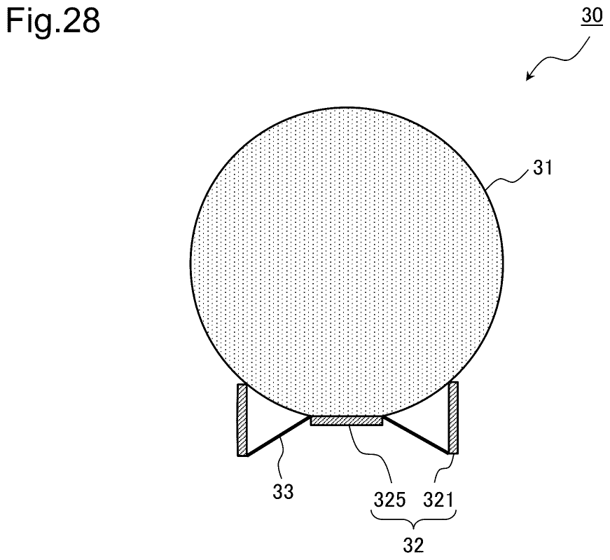

FIGS. 27 to 28 are conceptual diagrams illustrating an example of a configuration of the receiver 30 according to the present example embodiment. FIG. 27 is a side view of the receiver 30 as viewed from the lateral direction. FIG. 28 is a cross-sectional view of the receiver 30. The receiver 30 includes a ball lens 31, a light receiver 32, and a reflector 33.

The ball lens 31 is placed on a ring formed by the light-receiving ring 321. The light receiver 32 includes a light-receiving ring 321 and a light-receiving plate 325. The light-receiving ring 321 includes a plurality of light-receiving elements 320 arranged in an annular shape. The plurality of light-receiving elements 320 constituting the light-receiving ring 321 is arranged with the light-receiving surface facing the inner side of the ring formed by the light-receiving ring 321. The light-receiving plate 325 includes at least one light-receiving element 320. The light-receiving element 320 included in the light-receiving plate 325 is disposed inside the ring formed by the light-receiving ring 321 with the light-receiving surface facing the ball lens 31 mounted on the light receiver 32. The reflector 33 is disposed in a gap formed between the light-receiving ring 321 and the light-receiving plate 325.

As described above, the receiver of the present example embodiment condenses light signals arriving from various directions by the ball lens. The light signal condensed by the ball lens is condensed on the light-receiving ring or the reflector. The light signal condensed on the light-receiving ring is received by the light-receiving element constituting the light-receiving ring. The light signal condensed on the reflector is reflected by the reflecting surface of the reflector, and received by the light-receiving element constituting one of the light-receiving rings. Therefore, according to the receiver of the present example embodiment, light signals arriving from various directions can be efficiently received.

(Hardware)

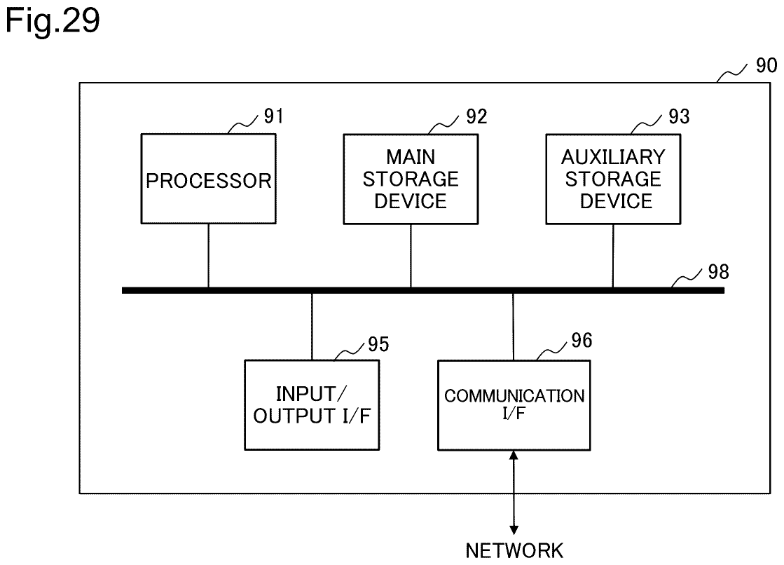

Here, a hardware configuration for executing control and processing according to each example embodiment of the present disclosure will be described using an information processing device 90 of FIG. 29 as an example. Note that the information processing device 90 in FIG. 29 is a configuration example for executing control and processing of each example embodiment, and does not limit the scope of the present disclosure.

As illustrated in FIG. 29, the information processing device 90 includes a processor 91, a main storage device 92, an auxiliary storage device 93, an input/output interface 95, and a communication interface 96. In FIG. 29, the interface is abbreviated as an interface (I/F). The processor 91, the main storage device 92, the auxiliary storage device 93, the input/output interface 95, and the communication interface 96 are data-communicably connected to each other via a bus 98. The processor 91, the main storage device 92, the auxiliary storage device 93, and the input/output interface 95 are connected to a network such as the Internet or an intranet via the communication interface 96.

The processor 91 develops the program stored in the auxiliary storage device 93 or the like in the main storage device 92. The processor 91 executes the program developed in the main storage device 92. In the present example embodiment, a software program installed in the information processing device 90 may be used. The processor 91 executes control and processing according to each example embodiment.

The main storage device 92 has an area in which a program is developed. A program stored in the auxiliary storage device 93 or the like is developed in the main storage device 92 by the processor 91. The main storage device 92 is, for example, a volatile memory such as a dynamic random access memory (DRAM). In addition, a nonvolatile memory such as a magnetoresistive random access memory (MRAM) may be configured/added as the main storage device 92.

The auxiliary storage device 93 stores various types of data such as programs. The auxiliary storage device 93 is a local disk such as a hard disk or a flash memory. Various types of data may be stored in the main storage device 92, and the auxiliary storage device 93 may be omitted.

The input/output interface 95 is an interface for connecting the information processing device 90 and a peripheral device based on a standard or a specification. The communication interface 96 is an interface for connecting to an external system or device through a network such as the Internet or an intranet based on a standard or a specification. The input/output interface 95 and the communication interface 96 may be shared as an interface connected to an external device.

Input devices such as a keyboard, a mouse, and a touch panel may be connected to the information processing device 90 as necessary. These input devices are used for inputting information and settings. When the touch panel is used as the input device, the display screen of the display device may also serve as the interface of the input device. Data communication between the processor 91 and the input device may be mediated by the input/output interface 95.

The information processing device 90 may be provided with a display device for displaying information. In a case where a display device is provided, the information processing device 90 preferably includes a display control device (not illustrated) for controlling display of the display device. The display device may be connected to the information processing device 90 via the input/output interface 95.

Furthermore, the information processing device 90 may be provided with a drive device. The drive device mediates reading of data and a program from a recording medium, writing of a processing result of the information processing device 90 to the recording medium, and the like between the processor 91 and the recording medium (program recording medium). The drive device may be connected to the information processing device 90 via the input/output interface 95.

The above is an example of a hardware configuration for enabling control and processing according to each example embodiment of the present invention. Note that the hardware configuration of FIG. 29 is an example of a hardware configuration for executing control and processing according to each example embodiment, and does not limit the scope of the present invention. In addition, a program for causing a computer to execute control and processing according to each example embodiment is also included in the scope of the present invention. Further, a program recording medium in which the program according to each example embodiment is recorded is also included in the scope of the present invention. The recording medium can be achieved by, for example, an optical recording medium such as a compact disc (CD) or a digital versatile disc (DVD). The recording medium may be a semiconductor recording medium such as a universal serial bus (USB) memory or a secure digital (SD) card. The recording medium may be a magnetic recording medium such as a flexible disk, or another recording medium. In a case where the program executed by the processor is recorded in the recording medium, the recording medium corresponds to a program recording medium.

The components of each example embodiment may be arbitrarily combined. In addition, the components of each example embodiment may be realized by software or may be realized by a circuit.

The previous description of embodiments is provided to enable a person skilled in the art to make and use the present invention. Moreover, various modifications to these example embodiments will be readily apparent to those skilled in the art, and the generic principles and specific examples defined herein may be applied to other embodiments without the use of inventive faculty. Therefore, the present invention is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

1. A receiver comprising:
a light receiver including a light-receiving ring including a plurality of light-receiving elements arranged in an annular shape, and a light-receiving plate including at least one of the light-receiving elements;
a ball lens placed on a ring formed by the light-receiving ring; and
a reflector disposed in a gap formed between the light-receiving ring and the light-receiving plate, wherein
the plurality of light-receiving elements constituting the light-receiving ring are arranged with a light-receiving surface facing an inner side of the ring formed by the light-receiving ring, and
the light-receiving element included in the light-receiving plate is disposed inside the ring formed by the light-receiving ring with a light-receiving surface facing the ball lens placed on the light-receiving ring.

2. The receiver according to claim 1, wherein
the light-receiving ring includes:
a first light-receiving ring including a plurality of the light-receiving elements arranged in an annular shape; and
a second light-receiving ring including a plurality of the light-receiving elements arranged in an annular shape with a diameter smaller than a diameter of the first light-receiving ring, and
the reflector includes:
a first reflector disposed in a gap formed between the first light-receiving ring and the second light-receiving ring; and
a second reflector disposed in a gap formed between the second light-receiving ring and the light-receiving plate.

3. The receiver according to claim 1, further comprising:
a reflecting body disposed in a dead region formed between light-receiving regions of the light-receiving elements adjacent to each other with a reflecting surface facing the ball lens.

4. The receiver according to claim 1, wherein
the light-receiving ring includes:
a first light-receiving ring including a plurality of the light-receiving elements arranged in an annular shape;
a second light-receiving ring including a plurality of the light-receiving elements arranged in an annular shape with a diameter smaller than a diameter of the first light-receiving ring; and
a third light-receiving ring including a plurality of the light-receiving elements arranged in an annular shape with a diameter smaller than the diameter of the second light-receiving ring, and
the reflector includes:
a first reflector disposed in a gap formed between the first light-receiving ring and the second light-receiving ring;
a second reflector disposed in a gap formed between the second light-receiving ring and the third light-receiving ring; and
a third reflector disposed in a gap formed between the third light-receiving ring and the light-receiving plate.

5. The receiver according to claim 1, further comprising:
a retroreflector that has a retroreflective surface and is arranged along an outer periphery of the light-receiving ring with the retroreflective surface facing an arrival direction of a spatial light signal.

6. The receiver according to claim 5, further comprising:
a modulation element that is disposed at a preceding stage of the retroreflector and modulates the incident spatial light signal.

7. A receiving device comprising:
the receiver according to claim 1; and
a receiving circuit that acquires a signal received by the receiver and decodes the acquired signal.

8. The receiving device according to claim 7, wherein
the receiving circuit detects an arrival direction of a spatial light signal that is a source of the light signal according to a position of a light-receiving element that has received the light signal.

9. A communication device comprising:
the receiving device according to claim 7;
a transmitting device that transmits a spatial light signal; and
a control device that comprises
a memory storing instructions; and
a processor connected to the memory and configured to execute the instructions to
acquire a signal based on a spatial light signal from another communication device received by the receiving device,
execute processing according to the acquired signal, and
cause the transmitting device to transmit a spatial light signal according to the executed processing.

10. A communication system comprising:
a plurality of the communication devices according to claim 9, wherein
the plurality of the communication devices are arranged to transmit and receive spatial light signals to and from each other.
